(19) United States
(12) Patent Application Publication
(10) Pub. No.: US 2025/0203517 A1
(43) Pub. Date: Jun. 19, 2025

(54) Methods And Apparatus For Generating On-Off Keying Signal In Mobile Communications

(71) Applicant: MediaTek Inc., Hsinchu City (TW)

(72) Inventors: Chien-Chun Cheng, Hsinchu City (TW); Chiao-Yao Chuang, Hsinchu City (TW); Chiou-Wei Tsai, Hsinchu City (TW); Jun-Qiang Cheng, Beijing (CN); Tai-Cheng Tsai, Hsinchu City (TW); Wei-De Wu, Hsinchu City (TW); Tao Chen, Beijing (CN); You-Wei Chen, San Jose, CA (US)

(21) Appl. No.: 18/929,527

(22) Filed: Oct. 28, 2024

Related U.S. Application Data
(60) Provisional application No. 63/611,221, filed on Dec. 18, 2023.

(30) Foreign Application Priority Data
Dec. 22, 2023 (WO) PCT/CN2023/141181
Oct. 16, 2024 (CN) 202411447920.8

(51) Int. Cl. H04W 52/02; H04L 27/04; H04W 56/00

(52) U.S. Cl. CPC H04W 52/0229; H04W 56/0015; H04L 27/04

(57) ABSTRACT

Various solutions for on-off keying (OOK) signal generation with respect to reader apparatus and an Internet of Things (IoT) device are described. A reader apparatus may generate an OOK signal with an orthogonal frequency-division multiplexing (OFDM) waveform, wherein a start of an OOK signal transmission is aligned with a boundary of a symbol of the OFDM waveform. The reader apparatus may transmit the OOK signal to an IoT device.

### CROSS REFERENCE TO RELATED PATENT APPLICATION(S)

The present disclosure is part of a non-provisional application claiming the priority benefit of U.S. Patent Application No. 63/611,221, filed 18 Dec. 2023, PCT Application No. PCT/CN2023/141181, filed 22 Dec. 2023, and CN application No. 202411447920.8, filed 16 Oct. 2024. The contents of aforementioned applications are herein incorporated by reference in their entirety.

### TECHNICAL FIELD

The present disclosure is generally related to mobile communications and, more particularly, to on-off keying (OOK) signal generation with respect to reader apparatus and internet of things (IoT) device in mobile communications.

### BACKGROUND

Unless otherwise indicated herein, approaches described in this section are not prior art to the claims listed below and are not admitted as prior art by inclusion in this section.

Wireless communication systems may be widely deployed to provide various telecommunication services such as telephony, video, data, messaging, and broadcasts. Typical wireless communication systems may use multiple-access technologies capable of supporting communication with multiple users by sharing available system resources. Examples of such multiple-access technologies may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G long term evolution (LTE) standard. There exists a need for further improvements in 5G NR technology. These improvements may also be applicable to other multi-access technologies and the telecommunication standards that employ these technologies.

Traditionally, an IoT device may use the on-off keying (OOK) for synchronization with the reader apparatus (e.g., UE readers or network node). However, the IoT device is not able to directly use/read the legacy 5G NR signals, e.g., a synchronization signal (SS).

Accordingly, how to provide the OOK signal for IoT transmission in the wireless communication environments such as 5G NR becomes an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to on-off keying (OOK) signal generation with respect to reader apparatus and internet of things (IoT) device in mobile communications. It is believed that the above-described issue would be avoided or otherwise alleviated by implementing one or more of the proposed schemes described herein.

In one aspect, a method may involve a reader apparatus generating an OOK signal with an orthogonal frequency-division multiplexing (OFDM) waveform, wherein a start of an OOK signal transmission is aligned with a boundary of a symbol of the OFDM waveform. The method may also involve the reader apparatus transmitting the OOK signal to an IoT device.

In another aspect, a method may involve an IoT device receiving an OOK signal from a reader apparatus, wherein the OOK signal is formed by an OFDM waveform, and wherein a start of an OOK signal transmission is aligned with a boundary of a symbol of the OFDM waveform. The method may also involve the IoT device performing a backscattering transmission according to the OOK signal.

In another aspect, a reader apparatus may involve a transceiver which, during operation, wirelessly communicates with at least one network node. The apparatus may also involve a processor communicatively coupled to the transceiver such that, during operation. The processor may generate an OOK signal with an OFDM waveform, wherein a start of an OOK signal transmission is aligned with a boundary of a symbol of the OFDM waveform. The processor may also transmit, via the transceiver, the OOK signal to an IoT device.

It is noteworthy that, although description provided herein may be in the context of certain radio access technologies, networks and network topologies such as 5th Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for an A-IoT transmission architecture in accordance with implementations of the present disclosure.

FIG. 3 is a diagram depicting another example scenario for an A-IoT transmission architecture in accordance with implementations of the present disclosure.

FIG. 4 is a diagram depicting an example scenario for a reader apparatus or an IoT device in accordance with implementations of the present disclosure.

FIG. 5 is a diagram depicting another example scenario for a reader apparatus or an IoT device in accordance with implementations of the present disclosure.

FIG. 6 is a diagram depicting another example scenario for a reader apparatus or an IoT device in accordance with implementations of the present disclosure.

FIG. 7 is a diagram depicting an example scenario for a communication process in accordance with implementations of the present disclosure.

FIG. 8 is a diagram depicting an example scenario for a transmission architecture between a network node and an A-IoT device in accordance with implementations of the present disclosure.

FIG. 9 is a diagram depicting an example scenario for a transmission procedure in accordance with implementations of the present disclosure.

FIG. 10 is a diagram depicting an example scenario for a guard band configuration in accordance with implementations of the present disclosure.

FIG. 11 is a diagram depicting another example scenario for a guard band configuration in accordance with implementations of the present disclosure.

FIG. 12 is a diagram depicting an example scenario for a guard band configuration process in accordance with implementations of the present disclosure.

FIG. 13 is a diagram depicting an example scenario for a harmonized waveform in accordance with implementations of the present disclosure.

FIG. 14 is a diagram depicting an example scenario for an OOK signal in accordance with implementations of the present disclosure.

FIGS. 15A-15B are diagrams depicting an example scenario for a configuration exchange process in accordance with implementations of the present disclosure.

FIG. 16 is a diagram depicting an example scenario for an OOK signal for LP-WUS signaling in accordance with implementations of the present disclosure.

FIG. 17 is a diagram depicting an example scenario for an OOK-1 signal and an OOK-4 for LP-WUS signaling in accordance with implementations of the present disclosure.

FIG. 18 is a diagram depicting an example scenario for a two stage process for WUS signaling in accordance with implementations of the present disclosure.

FIG. 19 is a diagram depicting another example scenario for a two-stage process for WUS signaling in accordance with implementations of the present disclosure.

FIG. 20 is a diagram depicting an example scenario for a table for a set of parameters for the operations of LP-WUR in accordance with implementations of the present disclosure.

FIG. 21 is a diagram depicting an example scenario for an LP-WUR in accordance with implementations of the present disclosure.

FIG. 22 is a diagram depicting an example scenario for an OOK WUR operated in a first stage in accordance with implementations of the present disclosure.

FIG. 23 is a diagram depicting an example scenario for an OOK WUR operated in a second stage in accordance with implementations of the present disclosure.

FIG. 24 is a diagram depicting an example scenario for an OFDM WUR in accordance with implementations of the present disclosure.

FIGS. 25A-25B are diagrams depicting an example scenario for an LP-WUS transmission process in accordance with implementations of the present disclosure.

FIG. 26 is a diagram depicting an example scenario for an LP-WUS placement in accordance with implementations of the present disclosure.

FIG. 27 is a diagram depicting another example scenario for an LP-WUS placement in accordance with implementations of the present disclosure.

FIG. 28 is a diagram depicting another example scenario for an LP-WUS placement in accordance with implementations of the present disclosure.

FIG. 29 is a diagram depicting an example scenario for different scheduling configurations in accordance with implementations of the present disclosure.

FIG. 30 is a diagram depicting another example scenario for different scheduling configurations in accordance with implementations of the present disclosure.

FIGS. 31A-31B are diagrams depicting an example scenario for an LP-WUS transmission process in accordance with implementations of the present disclosure.

FIG. 32 is a block diagram of an example communication system in accordance with an implementation of the present disclosure.

FIG. 33 is a flowchart of an example process in accordance with an implementation of the present disclosure.

FIG. 34 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to on-off keying (OOK) signal generation with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

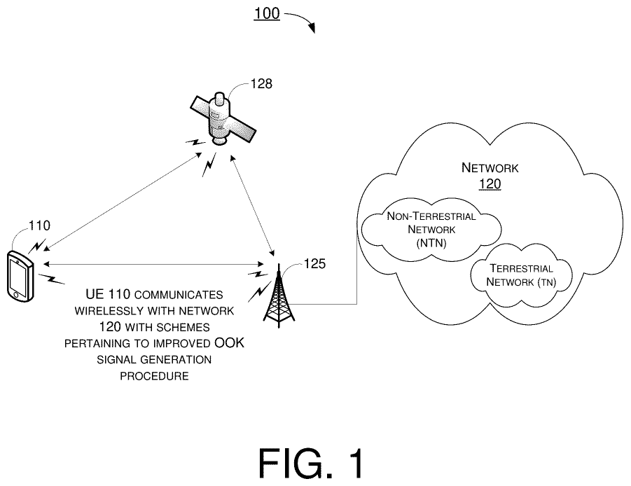

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to improved OOK signal generation procedure in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to the implementations of the present disclosure, a reader apparatus (e.g., the UE 110) may generate an OOK signal with an orthogonal frequency-division multiplexing (OFDM) waveform. A start of an OOK signal transmission may be aligned with a boundary of a symbol of the OFDM waveform. For example, for reader-to-device (R2D) transmission, if OFDM-based waveform is used, the start of R2D transmission from reader perspective may be assumed to be aligned with the boundary of a new radio (NR) OFDM symbol (including the cyclic prefix (CP)) for in-band or guard-band operation. After the OOK signal is generated, the reader apparatus may transmit the OOK signal to an Internet of Things (IoT) device (e.g., an ambient IoT (A-IoT) device). The IoT device may be a tag device. The IoT device may perform a backscattering transmission according to the OOK signal. According to the implementations of the present disclosure, the OOK signal may comprise at least one of an OOK-1 modulation and an OOK-4 modulation.

In an implementation, the reader apparatus may transmit a configuration associated with the OOK signal to the IoT device. The configuration may comprise at least one of a signal format and a bandwidth allocation of the OOK signal.

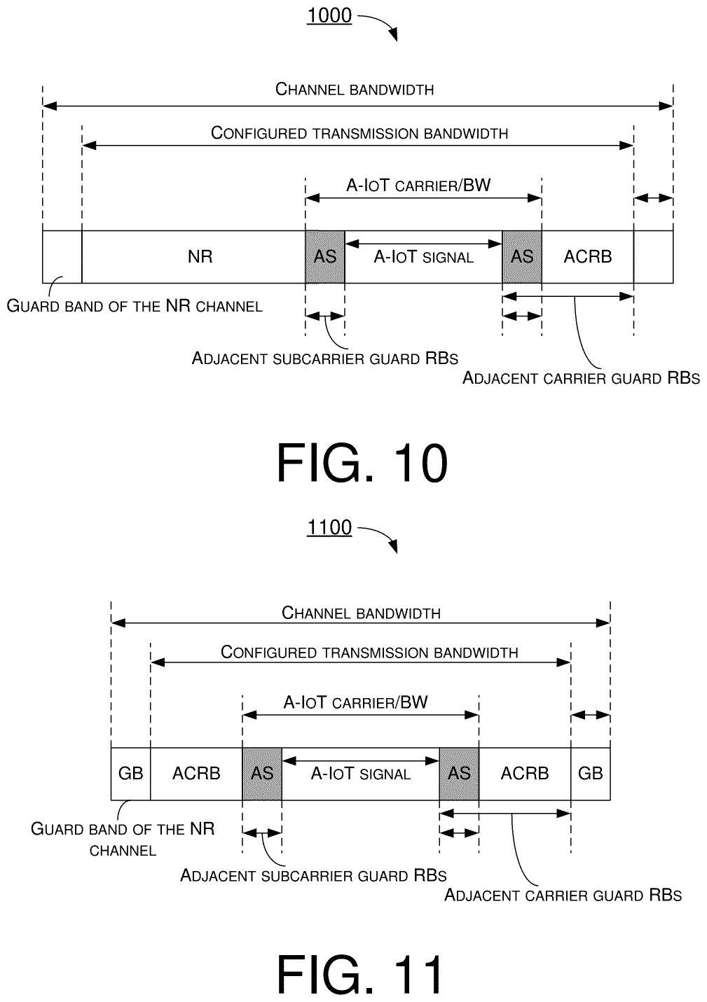

In an implementation, the reader apparatus may transmit a guard band configuration between the OOK signal and another OFDM signal to the IoT device, e.g., the guard band configurations of FIG. 10 and FIG. 11.

In an implementation, the OOK signal may comprise a wake-up signal to wake up the IoT device.

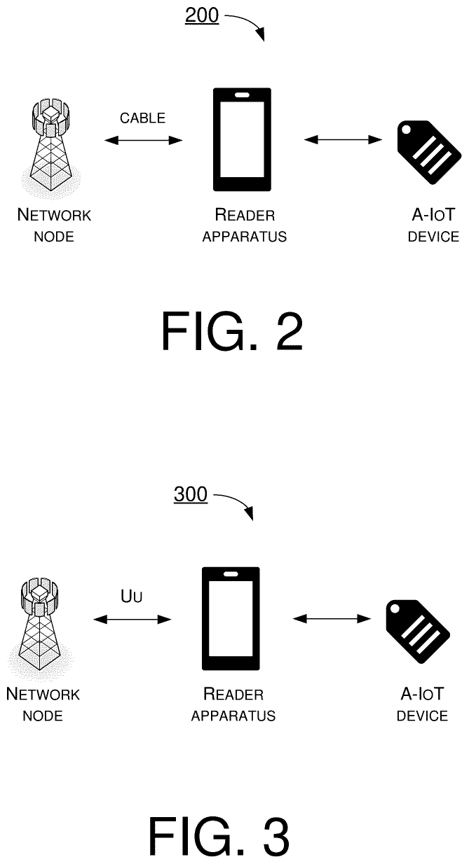

FIG. 2 illustrates an example scenario 200 for an A-IoT transmission architecture in accordance with implementations of the present disclosure. Scenario 200 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 2, the network node (e.g., a next-generation nodeB (gNB)) may establish a connection with the reader apparatus (e.g., a UE or a UE reader) via a wired cable. The configuration may eliminate the requirement for a new air interface between the network node and the A-IoT device. A new air interface between the reader apparatus and the A-IoT device may not be introduced. As shown in FIG. 2, the network node can access the A-IoT device via the reader apparatus. That is, the reader apparatus may be an intermediate node between the A-IoT device and the network node.

FIG. 3 illustrates another example scenario 300 for an A-IoT transmission architecture in accordance with implementations of the present disclosure. Scenario 300 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 3, the network node (e.g., a gNB) may establish a connection with the reader apparatus (e.g., a UE or a UE reader) via a wireless air interface. The air interface may be an NR-Uu interface to minimize the specification change on the reader apparatus. In addition, the air interface between the reader apparatus and the A-IoT device may be determined based on the use cases and requirements between the reader apparatus and the A-IoT device.

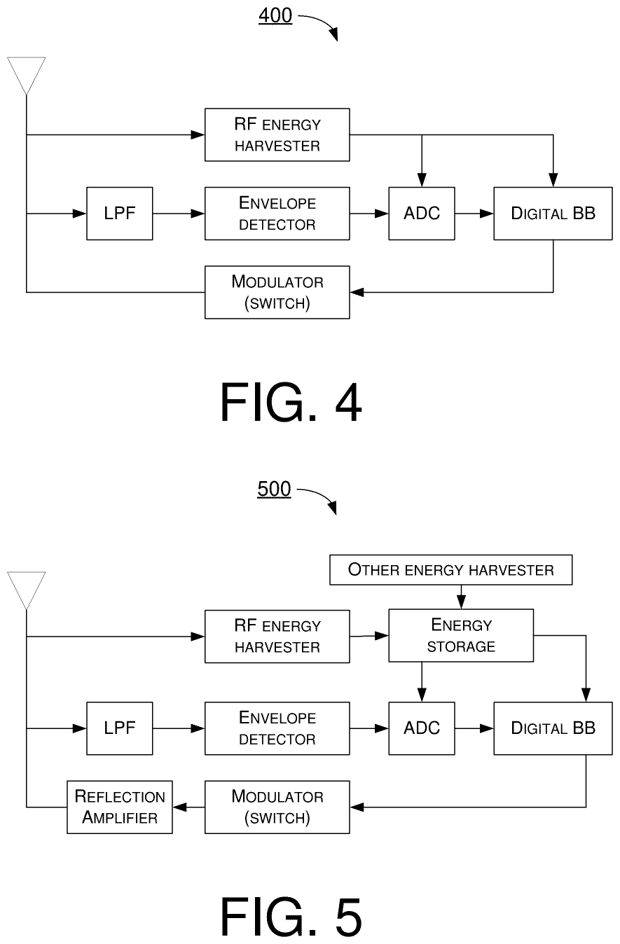

FIG. 4 illustrates an example scenario 400 for a reader apparatus or an IoT device in accordance with implementations of the present disclosure. Scenario 400 involves a reader apparatus. Referring to FIG. 4, the IoT device may be designed with specific targets. The IoT device may be designed for power consumption during transmission or reception (≤1 μW or ≤10 μW), and for complexity, which is aimed to be comparable to ultra-high-frequency radio-frequency-identification (UHF RFID) ISO18000-6C (EPC C1G2). In addition, as shown in FIG. 4, the IoT device may not have energy storage or independent signal generation and amplification capabilities. The IoT device may rely on backscattering transmission. The IoT device may require a backscattering activation power threshold, experience reflection loss, and need a distant carrier wave source to transmit signals for positioning. As shown in FIG. 4, the IoT device may comprise a low pass filter (LPF) for suppressing adjacent sub-carrier interference (ASCI) and adjacent carrier interference (ACI). The IoT device may also comprise an envelope detector (ED) to support OOK-based signals. The IoT device may also comprise an analog to digital converter (ADC) for digital baseband processing. The IoT device may also comprise a digital baseband (DBB) for sequence matching. The IoT device may also comprise a modulator (or a switch) controlled by the incoming signal to add payload data for OOK modulation. The IoT device may also comprise a radio frequency energy harvester to convert radio frequency (RF) signals into an energy source.

FIG. 5 illustrates another example scenario 500 for a reader apparatus or an IoT device in accordance with implementations of the present disclosure. Scenario 500 involves a reader apparatus. Referring to FIG. 5, the IoT device may be designed with specific targets. In addition, as show in FIG. 5, the IoT device may have energy storage but not have independent signal generation. The IoT device may rely on backscattering transmission. The stored energy may be used for signal amplification. The IoT device may also require a backscattering activation power threshold, experience reflection loss, and need a distant carrier wave source for positioning. As shown in FIG. 5, the IoT device may comprise an LPF for suppressing ASCI and ACI. The IoT device may also comprise an ED to support OOK-based signals. The IoT device may also comprise an ADC for digital baseband processing. The IoT device may also comprise a DBB for sequence matching. The IoT device may also comprise a modulator controlled by the incoming signal to add payload data for OOK modulation. The IoT device may also comprise an RF energy harvester to convert RF signals into an energy source. The IoT device may also comprise additional energy harvesters for different types of ambient power sources, such as RF radio, solar energy, thermal energy, and piezoelectric power. The IoT device may also comprise an energy storage, such as capacitors and solid-state batteries. The IoT device may also comprise a reflection amplifier to amplify the input signal to the tag and the backscattered signal towards the reader apparatus.

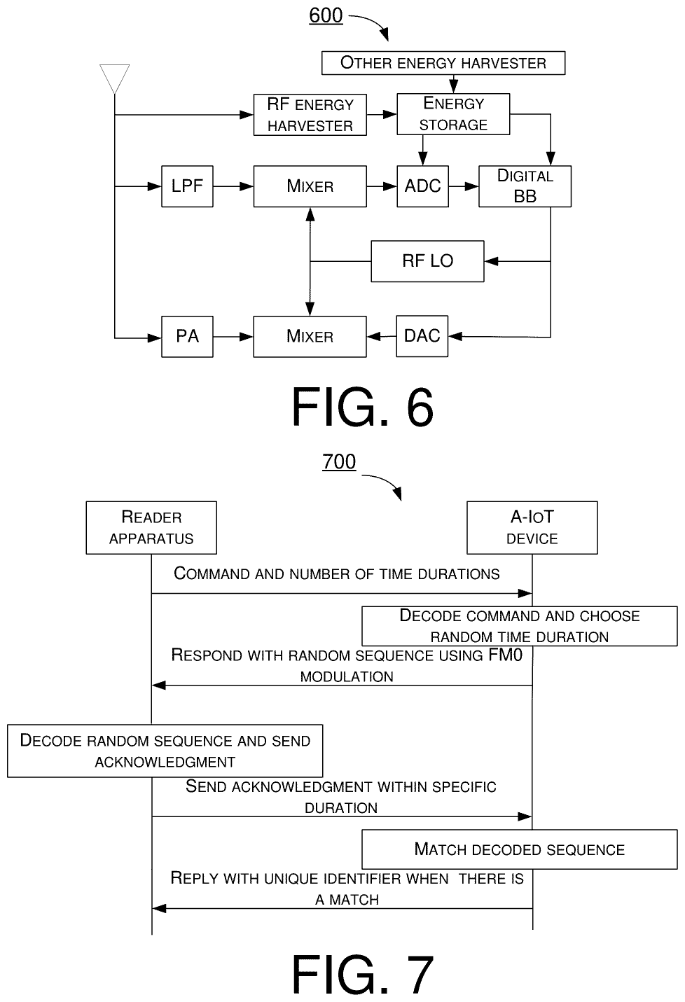

FIG. 6 illustrates another example scenario 600 for a reader apparatus or an IoT device in accordance with implementations of the present disclosure. Scenario 600 involves a reader apparatus. Referring to FIG. 6, the IoT device may be designed with specific targets. For example, the IoT device may be designed for a power consumption during transmission or reception (≤1 mW to ≤10 mW), and for a complexity that is orders-of-magnitude lower than Narrow Band IoT (NB-IoT). In addition, as shown in FIG. 6, the IoT device may have energy storage, independent signal generation, and active RF components for transmission. The IoT device may also have mobility management capabilities, at least for cell selection and re-selection. As shown in FIG. 6, the IoT device may comprise an LPF for suppressing ASCI and ACI. The IoT device may also comprise an ED to support OOK-based signals. The IoT device may also comprise an ADC for digital baseband processing. The IoT device may also comprise a DBB for synchronization, payload decoding, and cyclic redundancy check (CRC). The IoT device may also comprise an RF energy harvester to convert RF signals into an energy source. The IoT device may also comprise additional energy harvesters for different types of ambient power sources, such as RF radio, solar energy, thermal energy, and piezoelectric power. The IoT device may also comprise an energy storage, such as capacitors and solid-state batteries. The IoT device may also comprise a low-noise amplifier (LNA) and power amplifier (PA) to amplify reception and transmission signals.

FIG. 7 illustrates an example scenario 700 for a communication process in accordance with implementations of the present disclosure. Scenario 700 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 7, there may be an innovative air interface for communication between the reader apparatus (e.g., a UE reader or a network node (e.g., a gNB)) and the A-IoT device. As shown in FIG. 7, the communication process may be initiated when the reader apparatus powers up the A-IoT device and transmits a command. The command may comprise the essential communication parameters, e.g., the tag rate, the tag data encoding method, and the total number of available time durations. When the A-IoT device has harvested enough energy, the A-IoT device may be activated and listen for the command from the reader apparatus. After the A-IoT device decode the command, the A-IoT device may randomly select a time duration from the available range, and generate a random sequence. Then, the A-IoT device may transmit the random sequence to the reader apparatus in the chosen time duration. The random sequence may be modulated by frequency modulation 0 (FM0), and the random sequence may be preceded by a known preamble sequence. In response to the random sequence from the A-IoT device, the reader apparatus may decode the random sequence and send an acknowledgment back to the A-IoT device within a predetermined duration aligning with the configuration for the A-IoT rate. The reader apparatus discussed above may be a node, e.g., a UE, a UE reader a relay, IAB node, NR/LTE UE, repeater, or a base station (gNB).

According to an implementation of the present disclosure, the UE-to-A-IoT device communication link (U2A Link) may use modulation scheme like amplitude shift keying (ASK) or OOK to facilitate pulse interval encoding (PIE) for data transmission. The U2A link may include two preambles. One preamble is a long U2A preamble for initial transmission and the other preamble is a short U2A preamble for subsequent signaling. The UE may transmit the long U2A preamble and a control signal (or command) which is specifies the control parameters for the A-IoT device to the A-IoT device.

According to an implementation of the present disclosure, the A-IoT device-to-UE communication link (A2U Link) may use either ASK or phase shift keying (PSK) modulation. The A-IoT may encode backscattered data using either FM0 baseband or Miller modulation which is controlled by the UE or gNB via the A2U link. The A2U link signaling may be initiated with one of two Miller subcarrier preambles base on the command or the control signal. The A-IoT device may use backscatter modulation based on its antenna's reflection coefficient to transmit data. The A2U link may be used to transmit electronic product code (EPC) and protocol-control (PC) information.

According to implementations of the present disclosure, the existing network node (e.g., gNB) hardware may be used to generate OOK signals for A-IoT devices which use the backscattering transmission.

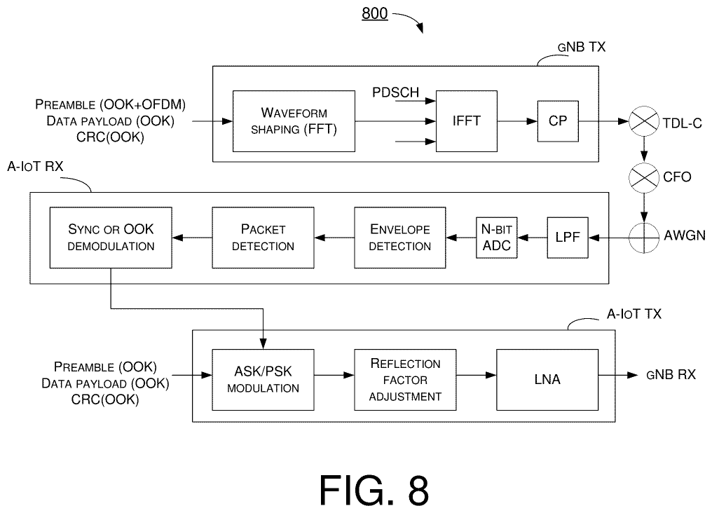

FIG. 8 illustrates an example scenario 800 for a transmission architecture between a network node and an A-IoT device in accordance with implementations of the present disclosure. Scenario 800 involves an A-IoT device and a network node (e.g., a (macro/micro) base station) which may be a part of a wireless network (e.g., an LTE network, a 5G/NR network, an IoT network or a 6G network). The network node also can be regarded as a reader apparatus, i.e., the scenario 800 also can be applied to another reader apparatus, e.g., a UE reader. Referring to FIG. 8, a transmission end of the network node (e.g., gNB TX) may perform a signal generation, a waveform shaping, an inverse fast Fourier transform (IFFT) multiplexing operation, and a cyclic prefix (CP) addition. A receiving end of the A-IoT device (e.g., A-IoT RX) may perform a low pass filter (LPF) function, an analog-to-digital convertor (ADC) operation, an energy detection, a packet detection, and a synchronization (or an OOK demodulation). A transmission end of the A-IoT device (e.g., A-IoT TX) may perform an ASK or PSK modulation, a reflection factor adjustment, and a LNA operation.

The transmitted OOK signal may comprise at least one of a preamble, a data payload, and a CRC. The preamble may be generated by an OFDM sequence. The OFDM sequence may be known by the A-IoT devices, UE reader, or gNB. The preamble may be used by the A-IoT devices for a synchronization, a packet detection, and a backscattering transmission. For example, the OFDM sequences may be used to overlay over the OOK symbols. The CRC type may be CRC-4, CRC-8, CRC-16, or CRC-32. In addition, the CRC type may be based on the error detection requirement of the A-IoT device.

The waveform shaping may be performed to generate the OOK waveform. The OOK waveform may have on and off periods in the time domain. A waveform shaping module may be needed to perform the waveform shaping. The waveform shaping module may be a least-squared solution of a linear matrix multiplexing to minimize the squared errors between the IFFT output and the target OOK waveform.

The IFFT module may multiplex the A-IoT signal with 5 MHz bandwidth and the physical downlink shared channel (PDSCH) signal with the rest of the bandwidth (15 MHz for example). The multiplexing operation may require guard resource blocks (RB) between A-IoT signal and NR PDSCH signal to prevent interference.

The CP adding operation may be performed to prevent interference from A-IoT signal to NR PDSCH signal. However, for A-IoT devices with OOK receivers, the CP may be redundant and as a result it may cause inter-symbol interference for OOK demodulation. In order to assist the A-IoT devices in removing the CP, the reader apparatus (e.g., gNB or UE reader) may broadcast assistance information (e.g., a subcarrier spacing (SCS), CP types, and a symbol index) in system information blocks (SIBs) or a query command.

An LPF may be needed to suppress adjacent sub-carrier interference (ASCI) and adjacent channel interference (ACI). The LPF requirement may be based on the A-IoT signal locations. Different signal locations may require different guard band resource blocks (RB) to prevent interference. The reader apparatus (e.g. gNB or UE reader) may transmit the configurations about the signal location and the number of guard band RBs via NR signal or channel to the A-IoT device.

The ADC may use few bits and a low sampling rate to save power consumption. If the reader apparatus (e.g., gNB or UE reader) requests the ADC information, the A-IoT device may report its ADC range, bits, or sampling rates. The ADC range may be related to the interference level, with higher interference requiring a wider ADC range.

The energy detector (ED) may be used to perform energy detection by extracting the absolute amplitude based on the correct direct current (DC) level. In order to obtain the correct DC level, the reader apparatus (e.g., gNB or UE reader) may send the preambles before data parsing. The preamble may be used by A-IoT devices for auto gain control (AGC), timing and frequency synchronization, and DC level estimation.

The packet detection module may monitor the specific time, frequency, and sequences for energy harvesting and A-IoT signal detection. The monitoring operation may be continuous if the traffic is on-demand and no periodic reporting is required. The known time, frequency resources, and sequences may be provided by the network from the reader apparatus (e.g., gNB or UE reader) when the connection between the A-IoT device and the reader apparatus is established.

In an example, after the packet detection and the coarse synchronization have been completed, the A-IoT device may use the preamble or the CRC to perform fine synchronization. In another example, the A-IoT device may perform OOK demodulation if the channel coding and modulation types are provided by the reader apparatus (e.g., gNB or UE reader) via the NR channel or signal.

If a packet is detected and the OOK signal is parsed successfully, the A-IoT device transmission may backscatter the detected and parsed OOK signal though the ASK or PSK modulation based on at least one of the UL preamble, data, and CRC of the OOK signal. The A-IoT devices may backscatter or reflect the OFDM signal underlaid in the OOK signal, if the reader apparatus (e.g., gNB or UE reader) provides the indications or the configurations via the NR channel or signal.

The reflection factor is used to control the reflection level of the output waveform. The reflection factor may modulate the output signal for the input information such as at least one of preamble, data payload, and CRC of the OOK signal. The A-IoT devices may only choose to reflect or not reflect on the received OOK signal, so the output signal may be ASK or FSK. The modulation types may be configurable by the reader apparatus (e.g., gNB or UE reader) via the NR channel or signal based on the capability reporting via the NR channel.

The LNA may be a reflecting amplifier which is used for UL power control. The amplifier power may be configured by the reader apparatus (e.g., gNB or UE reader) via the NR channel or signal. The A-IoT device may control its UL power by adjusting the LNA based on the received signal power.

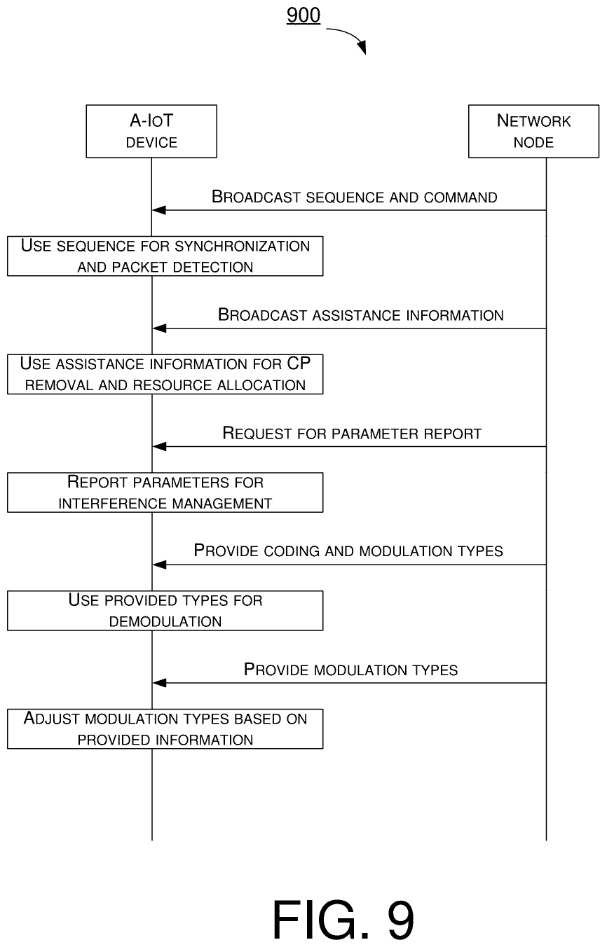

FIG. 9 illustrates an example scenario 900 for a transmission procedure between a network node and an A-IoT device in accordance with implementations of the present disclosure. Scenario 900 involves an A-IoT device and a network node (e.g., a (macro/micro) base station) which may be a part of a wireless network (e.g., an LTE network, a 5G/NR network, an IoT network or a 6G network). The network node also can be regarded as a reader apparatus, i.e., the scenario 900 also can be applied to another reader apparatus, e.g., a UE reader. Referring to FIG. 9, the transmission procedure may comprise the steps of broadcasting a sequence and a command, broadcasting assistance information, requesting for a parameter report, providing coding and modulation types, and providing modulation types. The corresponding actions of the A-IoT device in response to each network action are also depicted.

In the transmission procedure, the network node may initiate all actions. The network node may broadcast the sequence and command. The A-IoT device may use the sequence and command for synchronization and packet detection. Then, the network may broadcast the assistance information. The A-IoT device may use the assistance information for the CP removal and resource allocation. To manage interference levels, the network may also request a parameter report from the A-IoT device. Then, the A-IoT device may report its parameters to the network node for interference management. For the demodulation, the network may provide the coding and modulation types to the A-IoT device. The A-IoT device may use the provided coding and modulation types for demodulation. Finally, the network node may provide the modulation types to the A-IoT device, and then, the A-IoT device may adjust its modulation types based on this provided information.

As shown in FIG. 9, several key behaviors may be performed by the A-IoT device for the corresponding network signaling requirements.

For synchronization and packet detection, the A-IoT device may utilize a received sequence for synchronization and packet detection. A detection period may be initiated from a defined frame and may be governed by the smallest value in the set determined by the sequence period. During the detection period, all sequence block indexes may be mapped to the packet detection occasions at least once. The network node may broadcast a sequence and a command indicating the commencement of a packet. The sequence period may be derived from the relevant system information.

For the operations of the removal of the CP and the resource allocation, the A-IoT device may use the received assistance information. The allocation period which initiates from a defined frame may be determined by the smallest value in the set according to the CP configuration period. Within the allocation period, all CP block indexes may be mapped to the resource allocation occasions at least once. The network node may broadcast assistance information which comprises relevant parameters in system information blocks (SIBs) or a query command. The CP configuration period may be derived from the relevant system information.

The A-IoT device may also play a role in managing the interference level by reporting its parameters to the network node. The report period which initiates from a defined frame may be determined by the smallest value in the set according to the configuration period. Within the report period, all block indexes may be mapped to the interference management occasions at least once. The network may request the A-IoT device to report its parameters. The configuration period may be derived from the relevant system information.

For the demodulation, the A-IoT device may use the provided coding and modulation types. The demodulation period which initiates from a defined frame may be determined by the smallest value in the set according to the configuration period. Within the demodulation period, all block indexes may be mapped to the demodulation occasions at least once. The network may provide the specific coding and modulation types for demodulation. The configuration period may be derived from the relevant system information.

The A-IoT device may adjust its modulation types based on the information provided by the network. The adjustment period which initiates from a defined frame may be determined by the smallest value in the set according to the modulation configuration period. Within the adjustment period, all modulation block indexes may be mapped to the adjustment occasions at least once. The network may provide the specific modulation types based on the capability report of the A-IoT device. The modulation configuration period may be derived from the relevant system information.

As shown in FIG. 9, several key behaviors may be performed by the reader apparatus (e.g., gNB or UE reader) for the corresponding signaling requirements from the A-IoT device.

The reader apparatus (e.g., gNB or UE reader) may broadcast the sequence and command. The broadcast period may start from a defined frame and may be determined by the sequence period to ensue all sequence block indexes are broadcasted at least once within the broadcast period. The A-IoT device may need to receive the broadcast in the readiness state reported in the relevant system information.

The reader apparatus (e.g., gNB or UE reader) may broadcast assistance information for certain operations and resources. The broadcast period may start from a defined frame and may be determined by the assistance configuration period to ensure all assistance block indexes are broadcasted at least once within the broadcast period. The A-IoT device may request the assistance information in the request period obtained from the relevant system information.

The reader apparatus (e.g., gNB or UE reader) may use the reported parameters from the A-IoT device to manage the interference level. The management period may start from a defined frame and may be determined by the interference management configuration period to ensure all management block indexes are used at least once within the management period. The A-IoT device may reports its parameters in the reporting period obtained from the relevant system information.

The reader apparatus (e.g., gNB or UE reader) may provide the coding and modulation types to the A-IoT device. The provision period may start from a defined frame and may be determined by the provision configuration period to ensure all provision block indexes are provided at least once within the provision period. The A-IoT device may request the coding and modulation types in the request period obtained from the relevant system information.

The reader apparatus (e.g., gNB or UE reader) may provide modulation types based on the reported capabilities of the A-IoT device. The provision period may start from a defined frame and may be determined by the provision configuration period to ensure all provision block indexes are provided at least once within the provision period. The A-IoT device may report its capabilities in the reporting period obtained from the relevant system information.

The configuration and signaling of adjacent subcarrier and adjacent carrier guard resource blocks may be needed for A-IoT signals to ensure effective interference prevention and optimal performance in the communication networks.

FIG. 10 illustrates an example scenario 1000 for a guard band configuration in accordance with implementations of the present disclosure. Scenario 1000 involves an A-IoT device and a reader apparatus (e.g., a network node or a UE). Referring to FIG. 10, for the deployment position of the A-IoT signal, different numbers of guard resource blocks (e.g., blanked resource blocks) may be required. The guard resource blocks may be configured by the network node, and signaled from the network node to the UE reader or A-IoT device via NR signals and channels.

As shown in FIG. 10, the adjacent subcarrier guard resource blocks (ASRBs) may be added on both sides of the A-IoT signal bandwidth. The range of the ASRBs may be from 0.5 RB to 2 RBs for 30 kilohertz (KHz) subcarrier spacing (SCS), or from 1RB to 4 RBs for 15 KHz SCS. The ASRBs may be used to protect the A-IoT signal from interference from nearby the sub-carrier NR signals (e.g., PDSCH) or intra-cell interference. In addition, as shown in FIG. 10, the adjacent carrier guard resource blocks (ACRBs) may be added on one side of the A-IoT signal bandwidth when the channel bandwidth is more than 10 MHZ, or the A-IoT signal bandwidth is less than 5 MHz. The range of the ACRBs may be from 1 RB to 3 RBs for 30 KHz SCS, or from 2 RBs to 6 RBs for 15 KHz SCS. The ACRBs may be used to protect the A-IoT signal from interference from the nearby carrier NR signals, e.g., the inter-cell interference.

FIG. 11 illustrates another example scenario 1100 for a guard band configuration in accordance with implementations of the present disclosure. Scenario 1100 involves an A-IoT device and a reader apparatus (e.g., a network node or a UE). Referring to FIG. 11, the ACRBs may be added on both sides of the A-IoT signal bandwidth in a 5G network when the channel bandwidth is less than 10 MHz or the A-IoT signal bandwidth is more than 5 MHz.

The range of ACRBs may be from 1 RB to 3 RBs for 30 KHz SCS, or 2 RBs to 6 RBs for 15 KHz SCS. The ACRBs may be used to protect the A-IoT signal from interference from nearby carrier NR signals, e.g., the inter-cell interference. The number of ACRBs may be configured by the network node and signaled from the network node to the UE reader or A-IoT via NR signals and channels.

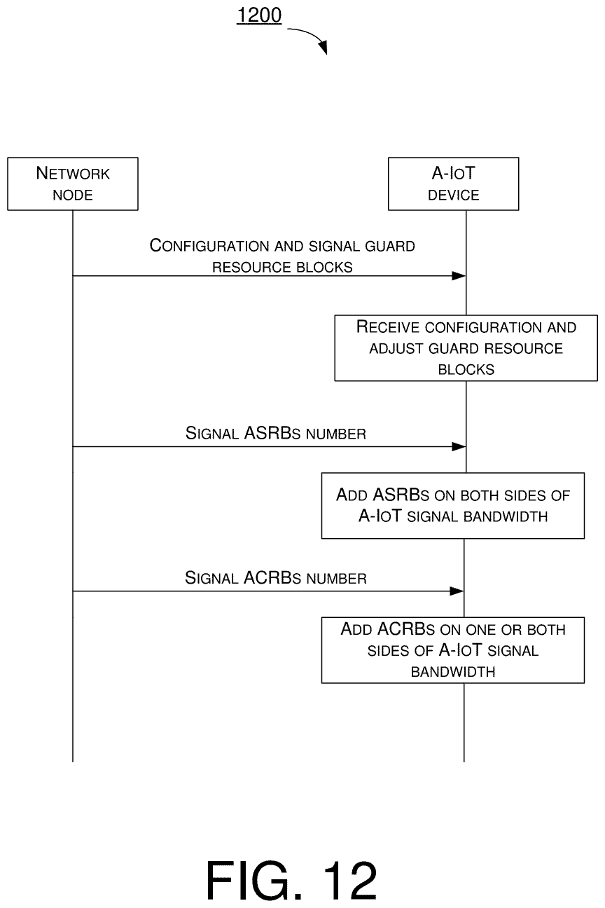

FIG. 12 illustrates an example scenario 1200 for a guard band configuration process in accordance with implementations of the present disclosure. Scenario 1200 involves an A-IoT device and a network node (e.g., a (macro/micro) base station) which may be a part of a wireless network (e.g., an LTE network, a 5G/NR network, an IoT network or a 6G network). The network node also can be regarded as a reader apparatus, i.e., the scenario 1200 also can be applied to another reader apparatus, e.g., a UE reader. Referring to FIG. 12, the network node may initiate the process by configuring and signaling the guard resource blocks to the A-IoT device. Upon receiving the configuration, the A-IoT device may adjust its guard resource blocks accordingly. Then, the network node may transmit or signal the number of ASRBs and ACRBs to the A-IoT device. The A-IoT device may add the guard resource blocks (i.e., the ASRBs and ACRBs) on the both sides or one side of its signal bandwidth based on the guard band configuration from the network node.

As shown in FIG. 12, several key behaviors may be performed by the A-IoT device for the corresponding network signaling requirements.

The A-IoT signals may be deployed at various positions within the channel bandwidth. According to the position, different numbers of guard resource blocks may be required. These guard blocks may be blanked resource blocks. The guard resource blocks may be used for mitigating the interference and ensuring the signal integrity. The network node may configure and signal the guard resource blocks to the A-IoT device via NR signals and channels to allow the A-IoT device to adapt to different deployment positions.

The ASRBs may be added on both sides of the A-IoT signal bandwidth. The ASRBs may be used to protect the A-IoT signal from interference from the nearby sub-carrier NR signals (such as PDSCH) or the intra-cell interference. The range of the ASRBs may be from 0.5 RB to 2 RBs for 30 KHz SCS, or from 1 RB to 4RBs for 15 KHz SCS. The network node may configure and signal the number of ASRBs to the A-IoT device to allow the A-IoT device to dynamically adjust according to the changes in the interference environment.

The ACRBs may be added to one or both sides of the A-IoT signal bandwidth according to the channel bandwidth and the A-IoT signal bandwidth. The ACRBs may be used to protect the A-IoT signal from interference from the nearby carrier NR signals, e.g., the inter-cell interference. The range of the ACRBs may be from 1 RB to 3 RBs for 30 KHz SCS, or from 2 RBs to 6 RBs for 15 KHz SCS. The network node may configure and signal the number of ACRBs to the A-IoT device to enabling the A-IoT device to effectively manage inter-cell interference.

The behaviors and signaling requirements may make the A-IoT devices can effectively manage interference and maintain optimal performance within the 5G network.

The non-unified synchronization in wireless communications may lead to lower efficiency, latency, higher power consumption, and data errors. As a result, the communication quality of the signals may be easily interfered by the interference and noise, especially in areas with dense device populations or poor signal conditions.

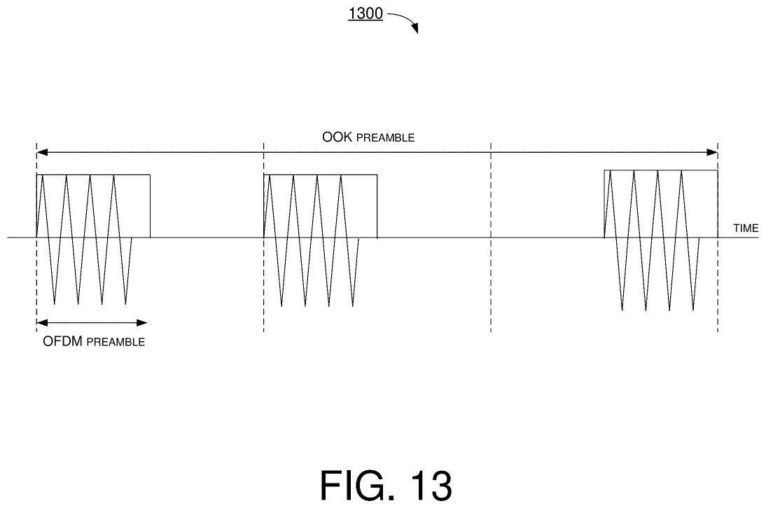

FIG. 13 illustrates an example scenario 1300 for a harmonized waveform in accordance with implementations of the present disclosure. Scenario 1300 involves an A-IoT device and a reader apparatus (e.g., a network node or a UE). Referring to FIG. 13, a harmonized waveform is generated. The A-IoT device may use an OOK preamble to overlay on the OFDM signals (or OFDM waveform) to generate an OOK signal to efficiently use the legacy signals (i.e., OFDM signals) and achieve the backscattering for enhanced communication.

Traditionally, the A-IoT devices may use the OOK for synchronization with UE readers or network node, but the A-IoT devices cannot directly use the legacy synchronization signals, e.g., the secondary synchronization signal (SSS). According to the implementations of the present disclosure, the OOK preamble can be overlaid on an OFDM waveform, e.g., primary synchronization signal (PSS) or SSS, i.e., the OFDM waveform may comprise a PSS or an SSS. Therefore, the underlaid signals (i.e., OFDM waveform) can be used for ON and OFF keying. For example, the SSS may be transmitted during the ON phase and a DC level signal may be transmitted during the OFF phase. The implementations of the harmonized or unified waveform may enable synchronization and data demodulation through OOK, and also allow the A-IoT devices to utilize the OFDM waveform for finer synchronization and additional information transfer. Therefore, both OOK sequence and OFDM sequence may be pre-configured in the A-IoT devices.

The passive A-IoT devices which use the backscattering for uplink transmission may reflect the preamble, either in full or partially, without embedding the OOK data. The OOK preamble may preserve the OFDM preamble during the ON phase. The UE reader or gNB may use the OOK preamble for faster uplink synchronization if the OOK preamble is pre-configured with the OFDM preamble knowledge to the UE reader or gNB. Utilizing multiple OFDM preambles during successive ON phases may further refine synchronization.

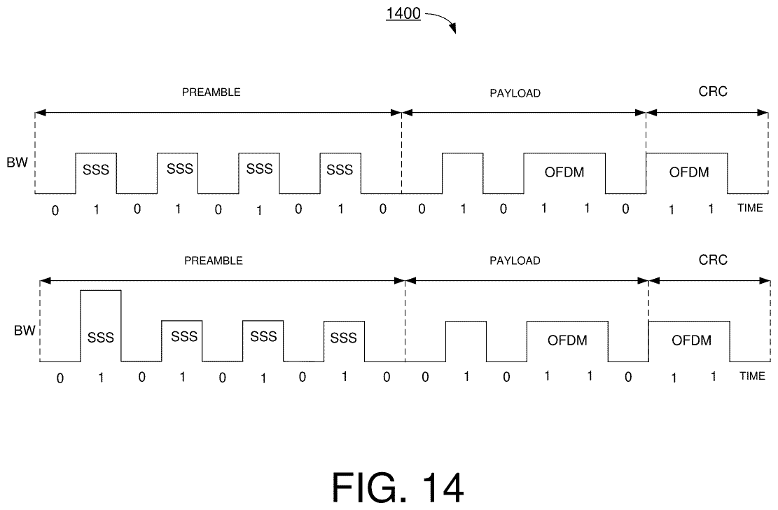

FIG. 14 illustrates an example scenario 1400 for an OOK signal in accordance with implementations of the present disclosure. Scenario 1400 involves an A-IoT device and a reader apparatus (e.g., a network node or a UE). Referring to FIG. 14, the OOK signal (i.e., a harmonized waveform) may comprises at least one of a preamble, a payload and CRC bits. The OOK signal may merge the OFDM broad bandwidth and have the robustness with the simplicity of OOK. Therefore, the OOK signal transmission may enhance the flexibility and synchronization efficiency of the A-IoT device in the diverse networks.

The harmonized waveform may enable the A-IoT device to use both OFDM and OOK signals. The OFDM is known for encoding data across multiple carriers, offering robustness and efficiency. The OOK is a simpler amplitude-shift keying modulation. The OOK may represent binary data through the presence or absence of a carrier signal which is typically within a 200 KHz to 500 KHz bandwidth. In contrast, the NR reference signals (e.g., PSS and SSS) operated within a much broader bandwidth, from 1.05 MHz up to 30.48 MHz may facilitate the synchronization in 5G networks.

The harmonized design for OOK signal may have two benefits. Firstly, the harmonized design may provide implementation flexibility. Therefore, the A-IoT devices can communicate across a diverse range of systems, which is particularly advantageous for the anticipated heterogeneity of 6G networks. Secondly, the harmonized design may streamline the synchronization by utilizing the OFDM preamble to save time and energy.

In scenarios with bandwidth discrepancies, an underlaid waveform strategy may remain viable. The system may need to be capable of detecting various bandwidths and adapting accordingly. It may involve a flexible receiver design, advanced signal processing to accommodate different bandwidths, and effective interference management to mitigate the challenges of concurrent signals with varying bandwidths. The strategies may ensure that an underlaid waveform approach can be effectively implemented, despite bandwidth variations, with the specifics tailored to the system's requirements and the signal characteristics.

For the harmonized waveform approach, the design and implementation may be agile to accommodate the varying bandwidths inherent in the A-IoT communications. The agility may be achieved through several key adaptations as follows.

The key adaptation may comprise the adaptive bandwidth detection. The A-IoT devices may have the capability to discern the bandwidth of incoming signals. By identifying the bandwidth, the A-IoT device may adjust its receiving parameters to align with the signal's characteristics to ensure accurate interpretation and processing.

The key adaptation may also comprise the versatile receiver architecture. The receiver architecture within the A-IoT devices may be inherently versatile, capable of handling the spectrum of bandwidths encountered. The flexibility can be realized through the deployment of sophisticated signal processing algorithms and modular hardware designs that can be dynamically configured.

The key adaptation may also comprise the advanced signal processing. In order to manage signals of varying bandwidths, the A-IoT devices may employ the advanced signal processing techniques. For example, multi-rate processing may allow the A-IoT device to adjust its processing speed to match the signal's bandwidth to ensure the efficient and accurate signal handling.

The key adaptation may also comprise the proactive interference management. In the environments where signals of different bandwidths coexist, the proactive interference management may become critical. The proactive interference management may involve the strategic scheduling of transmissions to minimize conflict, or involve the use of advanced multiplexing techniques (e.g., OFDM) to delineate and separate signals within the frequency domain to preserve the signal integrity.

By combining the above strategies, the A-IoT devices may effectively utilize an underlaid waveform approach to ensure the robust and flexible communication capabilities even when faced with diverse signal bandwidths. The harmonized design for OOK signal may not only facilitate backward compatibility with existing systems but also pave the way for forward compatibility with the emerging technologies. The harmonized design may ensure that the A-IoT devices remain the functional and relevant as the communication landscape evolves, particularly as we transition towards 6G networks where an even greater diversity of devices and communication standards is anticipated. The harmonized waveform may serve as a cornerstone for the future-proofing of the A-IoT devices to enable the A-IoT devices to adapt and thrive in the ever-changing ecosystem of wireless communication.

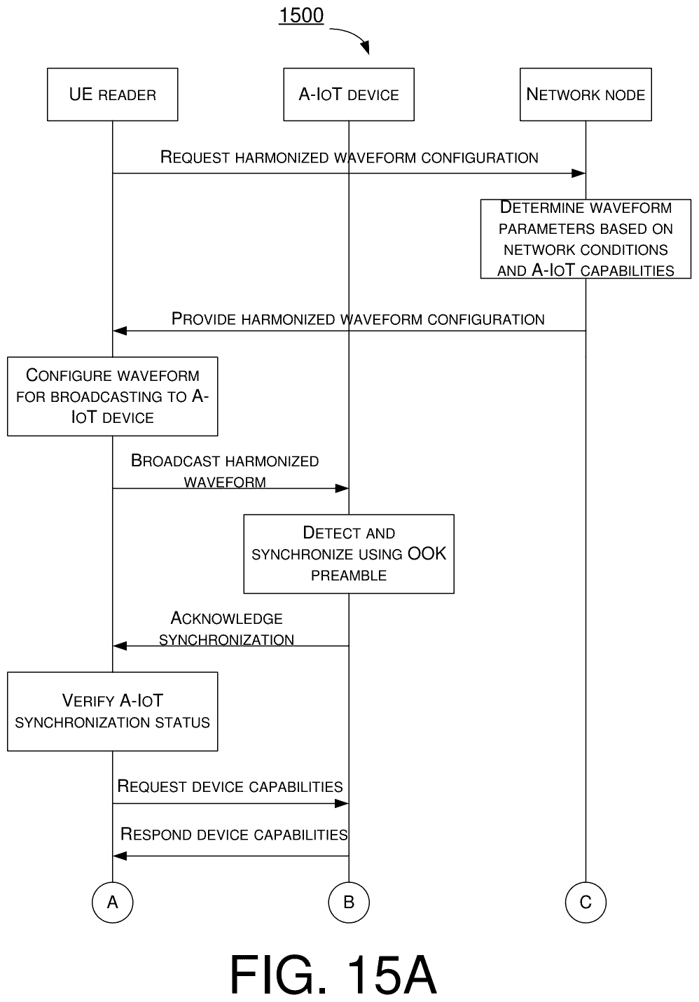

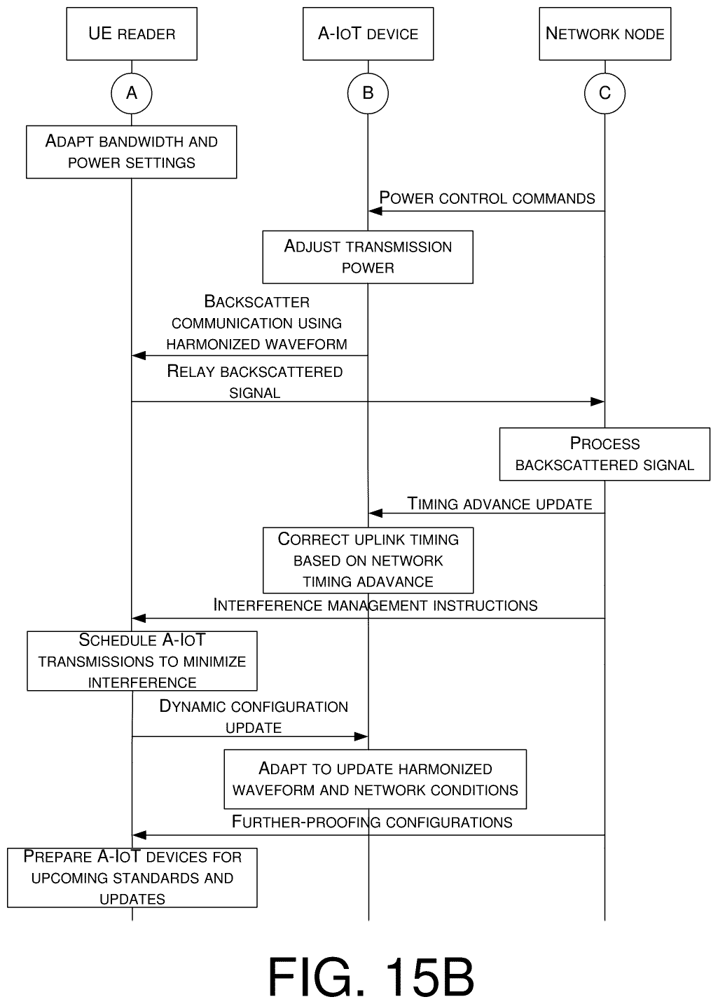

FIGS. 15A-15B illustrate an example scenario 1500 for a configuration exchange process in accordance with implementations of the present disclosure. Scenario 1500 involves a UE (or UE reader), an A-IoT device and a network node (e.g., a (macro/micro) base station) which may be a part of a wireless network (e.g., an LTE network, a 5G/NR network, an IoT network or a 6G network). Referring to FIGS. 15A-15B, the configuration exchange process may support the harmonized waveform of integrated OOK and OFDM signaling for the efficient A-IoT operation.

The configuration exchange process may begin with the UE reader requesting the harmonized waveform configuration from the network node. The network node may determine the appropriate waveform parameters based on the current network conditions and the capabilities of the A-IoT devices. Then, the network node may transmit or provide the parameters (i.e., the harmonized waveform configuration) to the UE reader. The UE reader may configure the harmonized waveform to the A-IoT device through broadcasting.

When the harmonized waveform is broadcasted by the UE reader, the A-IoT device may use the OOK preamble to detect and synchronize signals and transmit an acknowledgement for the synchronization to the UE reader. Then, the UE reader may request the device capabilities from the A-IoT device, and the A-IoT device may responds the device capabilities to the UE reader. Then, the UE reader may adapt the bandwidth and power settings for the specific A-IoT device.

The network node may send power control commands to the A-IoT device. Then, the A-IoT device may adjust its transmission power according to the power control commands. The A-IoT device may use the backscatter communication to reflect the harmonized waveform to the UE reader. Then, the UE reader may relay the harmonized waveform to the network node for uplink communication processing.

The network node may transmit the timing advance updates to the A-IoT device. The A-IoT device may correct uplink timing based on the timing advance updates. In addition, the network node may configure the interference management instructions to the UE reader. The UE reader may schedule the A-IoT transmissions and minimize potential interference according to the interference management instructions.

The UE reader may transmit the dynamic configuration updates to the A-IoT device. The A-IoT device may adapt to any updated harmonized waveform and changes in network conditions according to the dynamic configuration updates. Finally, the network node may transmit the future-proofing configurations to the UE reader. The UE reader may prepare the A-IoT devices for upcoming standards and technological updates according to the future-proofing configurations.

This configuration exchange process may be a guide for implementing the signaling required to support the harmonized design to ensure the robust and efficient communication for A-IoT devices within a dynamic communication ecosystem.

During the configuration exchange process, the A-IoT device supporting the harmonized design may perform several key operations to ensure efficient operation within the integrated OOK and OFDM framework.

The key operations may comprise the dual-mode synchronization. The A-IoT device may be capable of synchronizing with the network using both OOK and OFDM waveforms. The A-IoT device may use the simple OOK preamble for initial synchronization and then switch to the more complex OFDM waveform for fine synchronization to enhance the timing accuracy and network coordination.

The key operations may also comprise the configurability. The A-IoT device may be configurable to recognize and adapt to the harmonized waveform. The configurability may comprise the ability to process the underlaid OFDM signals during the OOK's ON periods and appropriately handle the DC level signals during the OOK's OFF periods.

The key operations may comprise the backscatter communication. The A-IoT device using the backscattering for uplink communication may reflect the harmonized waveform back to the reader or gNB without generating the modulated signal. Therefore, the design for the A-IoT device can be simplified and the power consumption can be reduced.

The key operations may also comprise the bandwidth adaptability. The A-IoT device may be equipped with the receivers that can detect and adapt to varying bandwidths. The bandwidth adaptability may be crucial for handling the different bandwidth requirements of the OOK and OFDM signals and for ensuring compatibility with various network standards.

The key operations may also comprise the energy efficiency. The A-IoT device may be optimized for energy efficiency, particularly in the synchronization processes. The A-IoT device may reduce the time and energy required for synchronization by using the more efficient OFDM preamble.

The key operations may also comprise the interference mitigation. The A-IoT device supporting the harmonized design may be also capable of mitigating interference through advanced signal processing techniques. The interference mitigation may ensure the reliable communication even if the A-IoT device is in the environments with high device density or in which there are competing signals.

The key operations may also comprise the forward compatibility. The A-IoT device may be built with a view toward future technological developments to ensuring that the A-IoT device can seamlessly integrate with upcoming standards and protocols to protect the investments and extend the lifespan of the A-IoT device.

In summary, the A-IoT device which supports the harmonized design may be versatile, configurable, and energy-efficient. The A-IoT device may have the advanced capabilities for synchronization, backscatter communication, and interference mitigation to ensure the robust performance in a dynamic communication ecosystem.

The UE reader supporting the harmonized design may perform the following operations to facilitate interaction with the A-IoT device using both OOK and OFDM signaling.

The operations may comprise the broadcasting harmonized waveform. The UE reader may be responsible for broadcasting the harmonized waveform, which includes the OOK preamble with an underlaid OFDM signal, to enable A-IoT devices to synchronize and communicate effectively.

The operations may also comprise the signal detection and decoding. The UE reader may perform the advanced signal detection and have the decoding capabilities to interpret the ON and OFF keying of OOK and extract information from the underlying OFDM waveform to ensure the accurate data demodulation from A-IoT device.

The operations may also comprise the adaptive bandwidth reception. The UE reader may adapt their reception to handle the different bandwidths of OOK and OFDM signals to maintain the compatibility with a variety of A-IoT devices and communication standards.

The operations may also comprise the interference management. The UE reader may use the interference management techniques to distinguish between multiple A-IoT devices transmitting simultaneously and to mitigate potential signal interference in a congested wireless environment.

The operations may also comprise the energy-efficient operation. The UE reader may perform the energy-efficient operation, especially during the synchronization phase, by quickly locking onto the more efficient OFDM preamble to conserve the power.

The operations may also comprise the backscatter signal processing. For the A-IoT device using backscattering, the UE reader may process the reflected harmonized waveform for uplink communication to establish synchronization and communication without requiring active transmission from the A-IoT device.

The operations may also comprise the dynamic configuration. The UE reader may be capable of dynamically configuring the harmonized waveform based on the operating environment and the requirements of the A-IoT device to ensure flexible and robust communication.

The operations may also comprise the forward compatibility. The UE reader may have forward compatibility to accommodate future advancements in the A-IoT technology and to integrate seamlessly with next-generation wireless networks.

The UE reader which supports the harmonized design may be equipped with the sophisticated broadcasting, signal processing, and adaptive capabilities to ensure the efficient and reliable communication with the A-IoT device in a mixed-signal environment.

The network node which supports the harmonized design may perform the following operations to manage the A-IoT device using the combined OOK and OFDM signaling.

The operations may comprise the unified waveform transmission. The network node may transmit the harmonized waveform, which integrates the OOK preamble (or OOK signal) with the OFDM waveform, to ensure the A-IoT device can effectively synchronize and communicate with the network node.

The operations may also comprise the advanced signal processing. The network node may have signal processing capabilities to decode the OOK signaling for initial synchronization and to extract additional information from the OFDM waveform for enhanced network coordination.

The operations may also comprise the bandwidth flexibility. The network node may handle the reception of signals across a range of bandwidths to accommodate the narrowband OOK as well as the broadband OFDM signals to support a diverse set of A-IoT devices.

The operations may also comprise the interference and noise mitigation. The network node may mitigate interference and noise to ensure the clear communication channels for the A-IoT device, even in the environments with high levels of signal traffic.

The operations may also comprise the energy-efficient synchronization. The network node may use the energy-efficient synchronization by quickly identifying and locking onto the OFDM preamble to reduce the time and power required for the A-IoT devices to synchronize.

The operations may also comprise the backscatter communication support. The network node may process backscattered harmonized waveforms from the A-IoT device to enable the uplink communication without activing the transmission from the A-IoT device.

The operations may also comprise the configurability and adaptation. The network node may be configurable to support the specific requirements of the A-IoT device and adapt the transmitted harmonized waveform based on the environmental conditions and device capabilities.

The operations may also comprise the technology evolution readiness. The network node may be future-proof and have the ability to support the evolving A-IoT technologies and seamlessly integrate with upcoming wireless communication standards.

The network node may use the above operations to play a pivotal role in the deployment and operation of the A-IoT device within the harmonized design framework to ensure the reliable, efficient, and scalable communication in the 5G and future 6G networks.

In order to support the harmonized design, specific signaling and configurations among UE readers, A-IoT devices, and gNBs, the following capabilities may be needed.

The capabilities may comprise the waveform configuration signaling. The network node and the UE reader may transmit the configuration of the harmonized waveform (e.g., a signal format and a bandwidth allocation of the OOK signal) to A-IoT devices. The configuration may comprise the structure of the OOK preamble and the parameters of the underlaid OFDM signal, e.g., the frequency allocation, the power levels, and the timing.

The capabilities may also comprise the synchronization parameters. The reader apparatus (e.g., network node and the UE readers) may transmit synchronization parameters to A-IoT devices to indicate how to use the harmonized waveform for the initial synchronization and subsequent fine synchronization using the OFDM component.

The capabilities may also comprise the bandwidth adaptation information. The signaling between the reader apparatus and A-IoT device may comprise the bandwidth adaptation information to allow the A-IoT device to adapt its receivers to the bandwidth of the harmonized waveform to ensure the A-IoT device can process both OOK and OFDM signals effectively.

The capabilities may also comprise the interference management instructions. The network node may provide instructions for managing interference. The instructions may comprise the timing and frequency domain coordination to avoid overlap and ensure clear signal reception.

The capabilities may also comprise the backscatter protocol configuration. For passive A-IoT device, the network node and UE reader may establish protocols for backscatter communication to define how the reflected harmonized waveform should be processed and interpreted.

The capabilities may also comprise the power control commands. In order to maintain the energy efficiency, the network node may transmit the power control commands to A-IoT device to indicate the A-IoT device when to increase or decrease power for synchronization and data transmission.

The capabilities may also comprise the timing advance updates. The network node may transmit the timing advance updates to the A-IoT device to correct the propagation delay and ensure that the uplink transmissions are correctly aligned with the network's timing.

The capabilities may also comprise the device capability exchange. The A-IoT device may transmit its capabilities (e.g., the supported bandwidths and modulation schemes) to the network node to enabling the network node to generate the harmonized waveform and other configurations for the A-IoT device.

The capabilities may also comprise the feedback and acknowledgment mechanisms. The reliable feedback mechanism may be that the A-IoT device may transmit the acknowledgement to the reader apparatus for the successful synchronization and configuration, or the A-IoT device may report any issues which need to be adjusted to the reader apparatus.

The capabilities may also comprise the future-proofing configurations. The signaling between the reader apparatus and A-IoT device may also carry the information for future updates and standards to ensure the long-term compatibility and reduce the requirement for hardware changes.

The A-IoT device, UE reader, and network node can effectively collaborate within the harmonized design framework through the comprehensive signaling and configuration exchange to ensure the robust and efficient communication in the integrated OOK and OFDM environment.

In the radio resource control (RRC)_IDLE state and RRC_INACTIVE state, the low power-wake up signal (LP-WUS) may be used to wake up the UE before paging occasions or system information change notifications. After detecting the LP-WUS, the UE may wake up its main receiver to monitor legacy paging or system information. The network node may transmit both of the LP-WUS and legacy paging (or system information) to ensure the coverage. The LP-WUS monitoring at the UE may be continuous or duty-cycled based on the configuration. For the partial LP-WUS coverage in the cell, the UE may need to track whether it is within the coverage to use LP-WUS or fall back to the legacy monitoring. The mobility measurements may be also relaxed when the LP-WUS is used to achieve power savings.

In the RRC_CONNECTED state, the LP-WUS may be used to wake up the UE before physical downlink control channel (PDCCH) monitoring occasions to reduce unnecessary PDCCH monitoring and power consumption. The LP-WUS monitoring may be continuous or duty-cycled. Several options may exist for how the LP-WUS is used in the conjunction with the connected-discontinuous reception (C-DRX) or the PDCCH monitoring configuration. For the partial coverage, the network node may need to explicitly activate or deactivate LP-WUS monitoring at the UE. The LP-WUS may also co-exist with downlink control information (DCI) with CRC scrambled by power saving-radio network temporary identity (PS-RNTI) (DCP). The UE may use one (LP-WUS or DCP) or the other based on the network configuration. The configuration of the timing between LP-WUS and PDCCH monitoring is needed to account for UE wake-up time.

The signaling or configuration of the LP-WUS properties may comprise the coverage, monitoring mode, timing/occasions, co-existence with legacy operations like paging, system information acquisition, C-DRX, etc. The signaling or configuration may allow the network node to control the UE to use the LP-WUS appropriately in the RRC_IDLE and RRC_CONNECTED states.

The two-stage LPWUS unified design, which integrates OOK-1, OOK-4, and OFDM wake-up signals, may face a technical challenge due to the increased complexity of signal processing. The complexity may adversely affect the key performance indicators such as the false alarm rate (FAR) and miss detection rate (MDR), particularly under varying signal-to-noise ratio (SNR) conditions. In order to ensure the power efficiency and maintain the detection reliability, a balance between signal harmonization and adaptive receiver configurations (e.g., power boosting and guard band management) may be required.

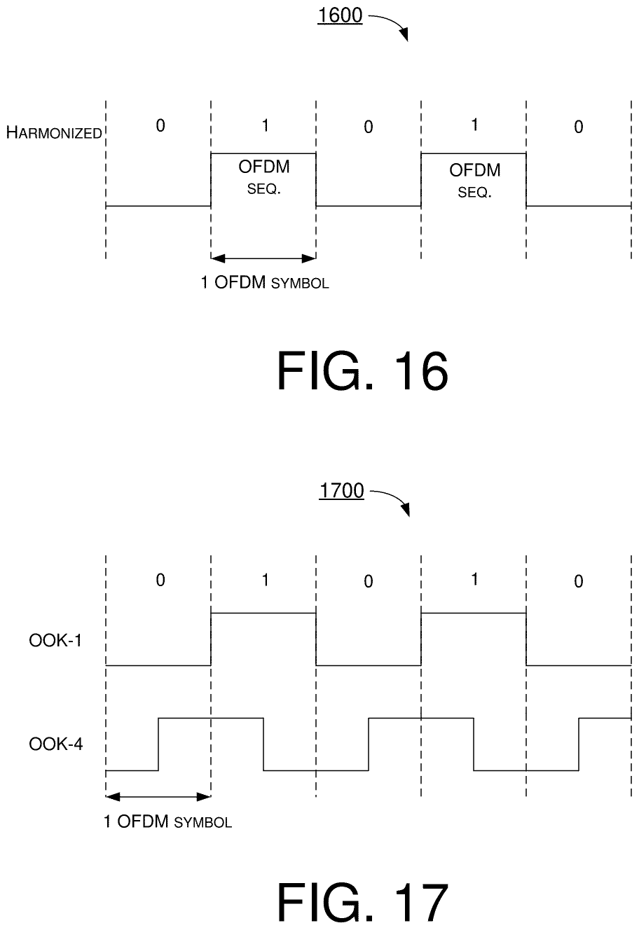

FIG. 16 illustrates an example scenario 1600 for an OOK signal for LP-WUS signaling in accordance with implementations of the present disclosure. Scenario 1600 involves an A-IoT device and a reader apparatus (e.g., a network node or a UE). Referring to FIG. 16, the OOK waveform and the OFDM waveform may be integrated for the purpose of LP-WUS signaling. As shown in FIG. 16, the specific OFDM sequences may be overlaid on top of OOK symbols to generate a composite signal which can be used for wake-up procedures.

The OOK component of the OOK signal may be generated through either OOK-1 modulation scheme or OOK-4 modulation scheme. The OOK-1 typically represents a single bit of information with one OFDM symbol, where the presence or absence of a carrier wave may be indicated through a bit (i.e., ‘1’ or ‘0’). In addition, the OOK-4 may represent multiple bits of information by transforming a multi-bit OOK signal in the time domain.

The OFDM sequences which are overlaid on the OOK symbols may be chosen for its properties which allow for efficient and reliable detection. The OFDM sequences may be designed to be orthogonal to each other to help in reducing interference and allow for the simultaneous transmission of multiple signals.

By combining the OOK and the OFDM in this way, the harmonized design may aim to leverage the simplicity and low-power benefits of the OOK modulation with the robustness and high data rates of OFDM modulation. According to the harmonized design for OOK signal, the reader apparatus and the A-IoT device may be operated effectively in variable conditions for the wake-up signaling process. The variable conditions may comprise that the reader apparatus and the A-IoT device may be operated in low signal-to-noise ratios, and still maintain low power consumption.

FIG. 17 illustrates an example scenario 1700 for an OOK-1 signal and an OOK-4 for LP-WUS signaling in accordance with implementations of the present disclosure. Scenario 1700 involves an A-IoT device and a reader apparatus (e.g., a network node or a UE). Referring to FIG. 17, the OOK-1 waveform and OOK-4 waveform may be generated for multi-carrier amplitude shift keying (MC-ASK) within an OFDM waveform for the LP-WUS.

As shown in FIG. 17, for OOK-1, a single bit of information is conveyed within one OFDM symbol. ‘N’ is represented as the number of subcarriers (SCs) allocated for the LP-WUS. The subcarriers may include guard bands to prevent interference with adjacent channels. When the OOK-1 bit is ‘1’, all N subcarriers are modulated, the subcarriers may carry power and can be detected at the receiver. Conversely, when the OOK-1 bit is ‘0’, all N subcarriers may be at zero power, the receiver may be effectively turned off the from a baseband perspective.

For OOK-4, multiple bits (e.g., ‘M’ bits) may be encoded into the time domain. The transformation from the M bits into N subcarriers is achieved through a process such as discrete Fourier transform (DFT) or a least squares method. The transformation may generate ‘N’ samples from the M-bit signal. According to some implementations, modifications to the signal, such as truncation or other alterations, may be applied. If no modifications are made, the number of generated samples is equal to ‘N’. The number of ‘N’ can also be equal to ‘K’ which is the size of the IFFT used in the CP-OFDMA system. Guard-band subcarriers may be set to zero power to maintain isolation from neighboring channels and signals.

FIG. 17 may be used to explain how OOK-1 and OOK-4 waveforms are generated and utilized within an OFDM framework for efficient LP-WUS. The modulation and transformation processes may enable the encoding of wake-up signals across multiple subcarriers.

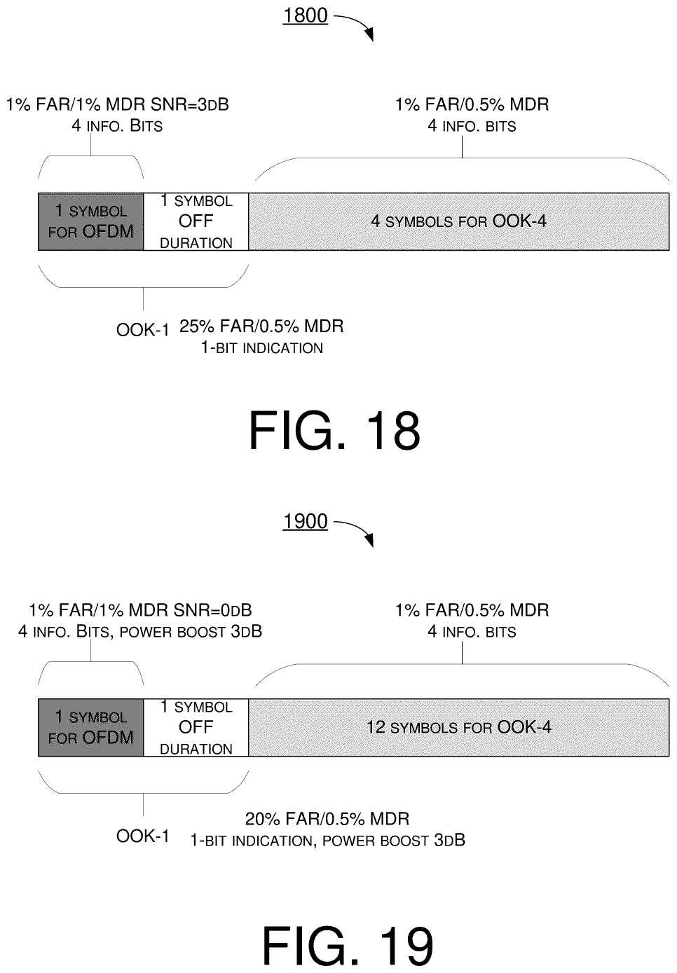

FIG. 18 illustrates an example scenario 1800 for a two-stage process for WUS signaling in accordance with implementations of the present disclosure. Scenario 1800 involves an A-IoT device and a reader apparatus (e.g., a network node or a UE). Referring to FIG. 18, the transmission overhead for both OOK and OFDM WUS may be reduced by leveraging the capabilities of the wake-up receivers (WUR) to minimize the number of symbols.

For the OOK WUS, the process may be divided into two stages. Initially, the OOK WUR may detect an OOK-1 symbol which comprises an indication bit. If the OOK-1 symbol is not detected, the OOK WUR may determine that no wake-up signal is present, and revert to sleep mode to conserve the energy. However, if an OOK-1 is detected and the false alarm rate (FAR) threshold is not exceeded, the OOK WUR may proceed to the second stage. In second stage, the OOK WUR may detect the subsequent OOK-4 symbols which carry four bits of information.

For OFDM WUS, the OFDM WUR may detect the first OFDM symbol to obtain the four information bits directly. The implementation of OFDM WUR may be efficient. However, when the OFDM WUS is repeated at every instance of the ‘1’ bit in the UE group ID, the repetition and potential inefficiency may be occurred.

FIG. 18 may also indicate that the network can handle the information bits for OOK-4 WUS and OFDM WUS in two ways. It can assume that the four information bits are the same for both OOK-4 and OFDM to allow the UE to decode one of the modulation schemes based on its implementation. However, the method may lead to waste the resources if the same information is sent twice. Alternatively, the network may send different information bits for OOK-4 and OFDM WUS to indicate the specific modulation scheme to be used through the system information (SI) message or Radio Resource Control RRC message. The method may optimize the resource use by ensuring that different information is conveyed through each signaling method.

FIG. 19 illustrates another example scenario 1900 for a two-stage process for WUS signaling in accordance with implementations of the present disclosure. Scenario 1900 involves an A-IoT device and a reader apparatus (e.g., a network node or a UE). Referring to FIG. 19, when the signal-to-noise ratio (SNR) is poor, the quality of the signal may be degraded. In such conditions, how to maintain the same level of miss detection rate (MDR) for wake-up signals may become more challenging and require additional resources.

Referring to FIG. 19, the OOK-4 signaling can be configured to extend over a longer duration, specifically up to 12 OFDM symbols, to improve the detection reliability. The network node may transmit the configuration to the UE via SI message or the RRC message.

In addition, to enhance the signal detectability, the power boosting may be applied. The power boosting may be a technique in which the transmitted signal power may be increased to improve the reception under the poor SNR conditions. The power-boosted signal may be used by the low power-WUR (LP-WUR) for the automatic gain control (AGC) training to help the receiver adjust its gain settings to capture the incoming signal.

Since the OFDM WUS benefits from the power boosting, the power boosting may also be applied to the corresponding OOK-1 signal, which is part of the two-stage wake-up process. Therefore, the LP-WUR can make a more accurate decision on whether to decode the OOK-1 signal. If the OOK-1 signal is sufficiently boosted and detected, the LP-WUR may decide to skip the subsequent OOK-4 decoding process and directly perform the reference signal received power (RSRP) measurement rules. The process takes into account the power boosting configurations to simplify the wake-up process and reduce the time which the LP-WUR spends in active monitoring. Therefore, the power consumption will be reduced.

In summary, referring to FIG. 19, in a low SNR environment, extending the duration of OOK-4 signaling and applying the power boosting may maintain the detection accuracy without compromising the efficiency of the LP-WUR.

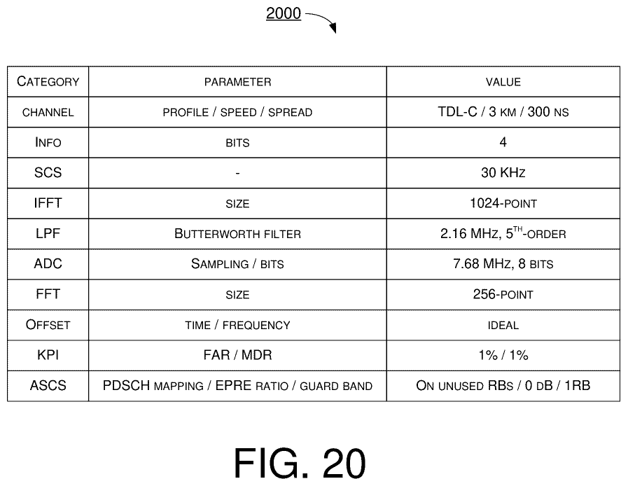

FIG. 20 illustrates an example scenario 2000 for a table for a set of parameters for the operations of LP-WUR in accordance with implementations of the present disclosure. Scenario 2000 involves an A-IoT device and a reader apparatus (e.g., a network node or a UE). Referring to FIG. 20, the table may illustrate a set of parameters which can be used to assess the performance of an LP-WUR. The channel characteristics may be specified by a tapped delay line (TDL)-C profile, which may be accompanied by a pedestrian (or user) speed of 3 kilometer (km)/hour (hr) and a multipath delay spread of 300 ns, to provide a realistic urban test scenario. The information payload may be confined to 4 bits and is used to indicate the data capacity of the wake-up signal.

The subcarrier spacing (SCS) may be established at 30 KHz. The SCS may be used to define the parameter for the frequency domain granularity in an OFDM system. The IFFT may be implemented with a 1024-point size. The IFFT may be used to dictate the granularity and duration of the OFDM symbol. The signal integrity may be maintained before digitization by a 5th-order Butterworth filter with a 2.16 MHz cutoff frequency.

The digitization of the analog signal may be achieved through an analog-to-digital Converter (ADC) operation at a sampling rate of 7.68 MHz and a quantization depth of 8 bits. A 256-point FFT may be used in the subsequent digital signal processing to transition the signal from the time domain to the frequency domain. The system may assume that the operations are in the ideal conditions with no time or frequency offsets.

The performance metrics (e.g., key performance indicator (KPI)) may calculate according to a false alarm rate (FAR) and a miss detection rate (MDR) to reflect the system's accuracy in signal detection. Both of the FAR and MDR may be set at a threshold of 1%. The configuration for an additional secondary cell state (ASCS) may comprise a mapping of the PDSCH on unused resource blocks, an energy per resource element (EPRE) ratio maintained at 0 dB, and a guard band comprising a single resource block mitigate interference.

The parameters shown in the table may influence the efficacy of the LP-WUR in signal detection. The main receiver may be capable of reporting the parameters back to the network node to enable the network node to tailor the system configuration. The dynamic adjustment may ensure that the LP-WUR operates optimally according to the reported capabilities and conditions conveyed through RRC messages.

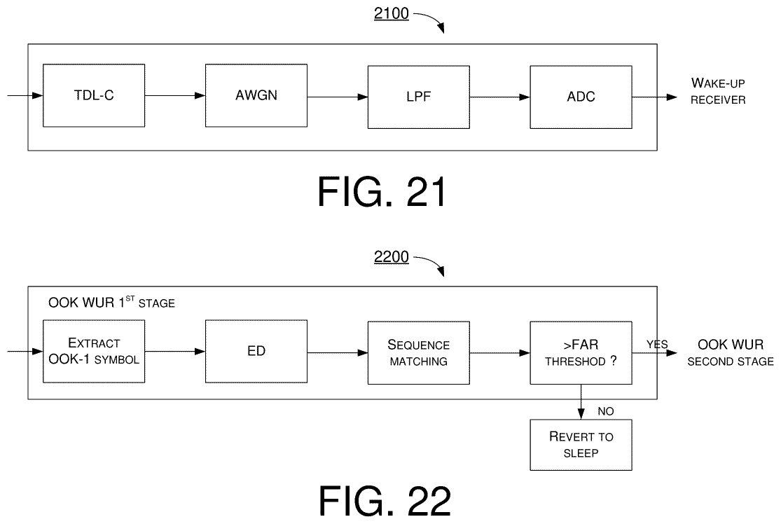

FIG. 21 illustrates an example scenario 2100 for an LP-WUR in accordance with implementations of the present disclosure. Referring to FIG. 21, an LP-WUR of a UE may be used to monitor low power signals with enhanced interference mitigation capabilities. The LP-WUR may comprise an LPF to attenuate unwanted high-frequency components from nearby sub-carriers and cells to ensure that the signal of interest is isolated from extraneous noise and interference. The LP-WUR may also comprise an ADC to convert the filtered analog signal into a digital representation for subsequent operations processed by the LP-WUR.

The main receiver (MR) within the UE may dynamically configure the LPF and ADC to adapt to varying signal conditions. The configuration may be informed through an array of environmental and operational parameters. The parameters may comprise the prevailing signal-to-noise ratio (SNR), the specific frequency bands in use, and the geographical location of the UE, particularly in relation to the cell edge. In addition, the MR may determine the configuration according to the location of the allocated time and frequency resources which may be situated at the periphery of the channel bandwidth, where the potential for interference may be increased.

The payload size may be defined according to the number of information bits which the LP-WUR needs to parse. The payload size may also influence the configuration of the LPF and ADC. The MR is capable of either reporting the parameters to the network node or autonomously determining the optimal LPF and ADC settings to ensure that the LP-WUR operates with the appropriate level. The adaptive mechanism may enable the LP-WUR to maintain its functionality and reliability across a spectrum of operating conditions to ensure that the wake-up signal can be accurately detected and processed.

FIG. 22 illustrates an example scenario 2200 for an OOK WUR operated in a first stage in accordance with implementations of the present disclosure. Referring to FIG. 22, an OOK WUR may decode an OOK-based WUS through a two-stage process. In the first stage, the OOK WUR may detect the presence of an OOK-WUS. The detection may be facilitated according to the extraction of OOK-1 symbols from the OOK-based WUS signal. The time and frequency resources used by the OOK-based WUS signal may have been pre-configured by the MR and the network node, and transmitted to the OOK WUR through the SI message or the RRC message.

The synchronization may be required for the accurate signal extraction. The synchronization may be achieved by leveraging the low-power synchronization signal (LPSS) or the synchronization signal Block (SSB), which the LP-WUR or MR has previously utilized. When the OOK-1 symbols are received, the OOK WUR may use an envelope detector (ED) to extract the amplitude information from the OOK-1 symbols. In addition, a sequence matching correlator may compute the correlation between the received OOK-1 symbols and a set of predetermined sequences which the network node and MR have configured and supplied.

The correlation result of the sequence matching process may then be evaluated against a FAR threshold. If the correlation result exceeds the FAR threshold, the OOK WUR may perform the operations in the second stage. In the second stage, the OOK WUR may monitor for additional OOK WUS to determine whether the main radio need to be activated or other specified actions need to be initiated. If the correlation result is not above the FAR threshold (i.e., below the FAR or equal to the FAR), it may mean that no significant match with the expected sequences. Therefore, the OOK WUR may terminate the monitoring and revert to a power saving state (e.g., enter a sleep mode or complete shutdown) to reduce power consumption.

The FAR threshold may be designed to target an FAR of 1%, although the rate may be not fixed and can be adjusted based on configurations set by the MR or network node. The flexibility may allow the system to balance the sensitivity of the OOK WUR to potential wake-up signals against the likelihood of false alarms to optimize the performance of the OOK WUR in line with the operational requirements of the network node and the conditions experienced by the UE.

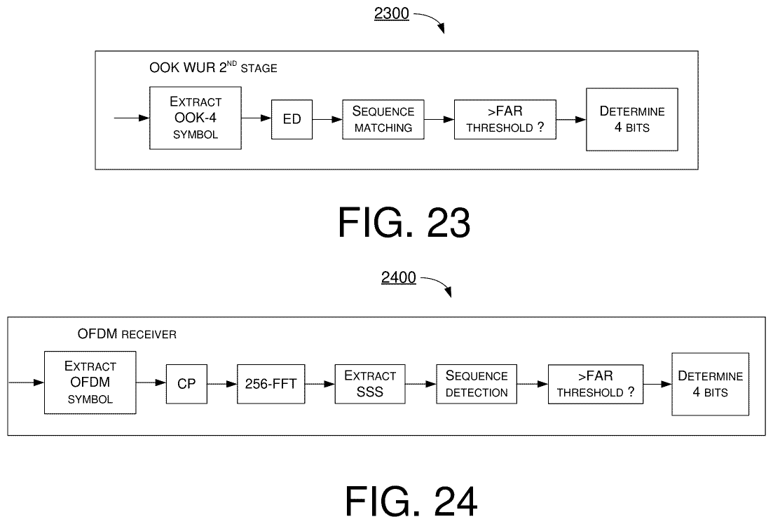

FIG. 23 illustrates an example scenario 2300 for an OOK WUR operated in a second stage in accordance with implementations of the present disclosure. Referring to FIG. 23, an OOK WUR may decode an OOK-based WUS through a two-stage process. The second stage may be triggered when the OOK WUR decides to continue monitoring after the first stage according to the parsing results of the OOK-1 symbols.

In the second stage, the OOK WUR may extract the OOK-4 symbols. The extraction process may be performed according to a set of configurations that have been provided by the MR and the network node. The configurations may comprise the allocation of time and frequency resources, and the level of power boosting applied to the signal. The power boosting may be a technique which is used to enhance the signal strength to improve the ability of the OOK WUR to detect the OOK-based WUS signal in the low SNR conditions.

The OOK WUR may use an ED and perform sequence matching in a manner similar to the first stage. The ED may be used for capturing the amplitude information of the OOK-4 symbols. The sequence matching may be used to compare the received OOK-4 symbols to a set of pre-determined sequences to determine whether the correlation between the received OOK-4 symbols and the expected sequences is sufficient to trigger the wake-up of the MR or to prompt other predefined actions.

The FAR threshold for the second stage may be adjustable and can be configured by the network node and MR. The FAR threshold may be associated with the second stage and may be used to manage the FAR in the second stage.

It should be noted that the configuration of the FAR may not be different to each individual stage. That is, the same FAR for the entire WUS process may be considered. The determination of whether to set different FAR threshold for each stage may be based on the UE implementation. The determination may allow for flexibility in how the OOK WUR sensitivity to wake-up signals is balanced against the probability of the false alarms to enable the receiver to meet the specific requirements and operational conditions of the network node and the UE.

FIG. 24 illustrates an example scenario 2400 for an OFDM WUR in accordance with implementations of the present disclosure. Referring to FIG. 24, an OFDM WUR may be used decode a wake-up signal using OFDM symbols. The OFDM WUR may operate based on the specific configurations that indicate the time and frequency resources for signal extraction. The configurations may be provided by the MR and the network node and transmitted to the OFDM WUR through the SI message or the RRC message.

The OFDM WUR may remove the CP from the received signal. The CP may be an integral part of the OFDM symbol which may be used to mitigate inter-symbol interference. The CP length may vary across different symbols. The slot format and timing information required to accurately remove the CP may be provides by the MR and network node.

Following the removal of the CP, the OFDM WUR may perform a 256-point FFT to convert the time-domain signal into the frequency domain signal. The OFDM WUR may also perform the extraction of the SSS-based OFDM WUS. The SSS-based OFDM WUS may use the sequences which are distinct from the existing NR SSS sequences. For instance, a Walsh-Hadamard sequence may be generated and its orthogonality with the SSS sequence may be verified through cross-correlation calculations.

The specific SSS-based sequence used for the wake-up process may be configured by the MR or network node and transmitted to the OFDM WUR through the SI message or the RRC message. The sequence detection may involve a correlation calculation with the known SSS sequences to detect the presence of the OFDM WUS.

An FAR threshold may be applied to determine whether the OFDM WUS has been sent by the network node. The FAR threshold may be typically set to target a 1% FAR, but it can be adjusted based on configurations from the MR or network node when the configurations are again transmitted through the SI message or the RRC message.

The final step in the process for the OFDM WUR may be to parse the LP-WUS information bits. The format (e.g., sequences and channel coding) of the LP-WUS may be provided by the network node or MR. According to the results from decoding the information bits, the LP-WUR may determine whether to activate the MR or to take other required actions. The determination process may be performed to ensure that the OFDM WUR can respond to the detected WUS appropriately according to the parsing results.

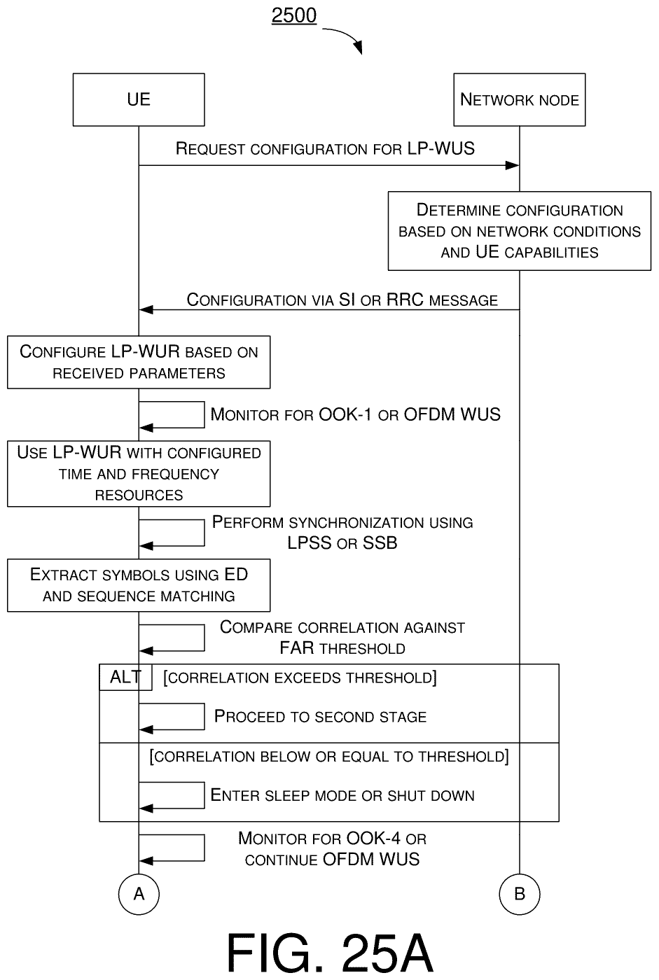

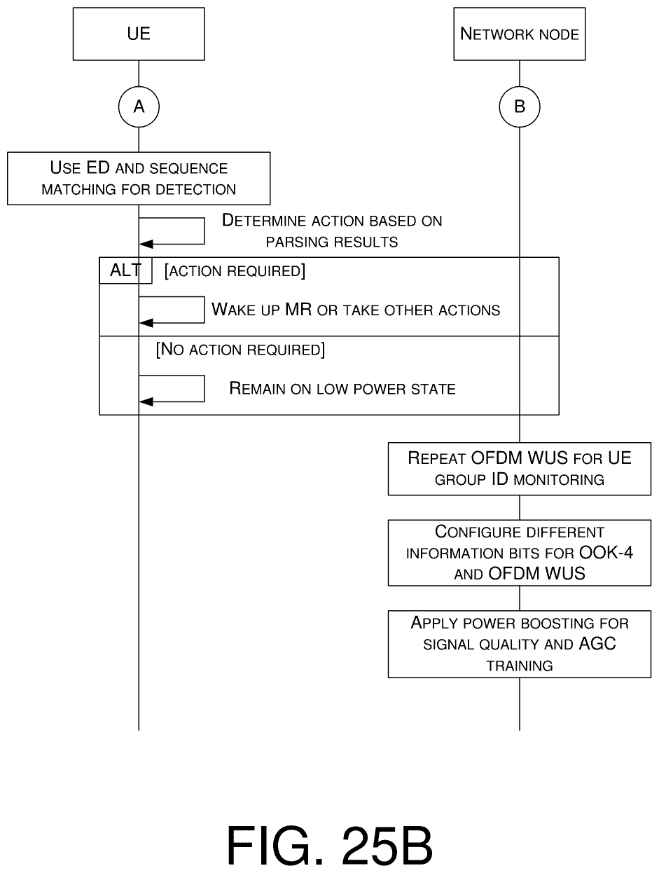

FIGS. 25A-25B illustrate an example scenario 2500 for an LP-WUS transmission process in accordance with implementations of the present disclosure. Scenario 2500 involves a UE and a network node (e.g., a (macro/micro) base station) which may be a part of a wireless network (e.g., an LTE network, a 5G/NR network, an IoT network or a 6G network). Referring to FIG. 25A-25B, the UE may request the LP-WUS configuration from the network node. The network node may determine the appropriate configurations or settings based on various factors, and transmit the configurations to the UE through the SI or the RRC message. Then, the UE may use its LP-WUR to monitor the initial wake-up signal (e.g., OOK-1 or OFDM WUS) and perform necessary synchronization and symbol extraction. If the correlation of the received signal exceeds a predefined threshold (e.g., FAR threshold), the UE may proceed to the second stage. Otherwise, the UE may enter a low power state.

In the second stage, the UE may continue to monitor for additional information (e.g., OOK-4 or continuation of OFDM WUS) and determine whether to activate the MR or take other actions according to the decoded information bits. The network node may repeat the OFDM WUS for the specific UE group ID monitoring. The network node may also configure different information bits for OOK-4 and OFDM WUS. The network node may also apply power boosting to assist in signal quality and automatic gain control (AGC) training.

The strategic placement of LP-WUS in relation to the SSB may optimize the monitoring duration and enhance energy efficiency. The location of LP-WUS (e.g., before or after SSB) may present the scheduling challenges because the location of LP-WUS may influence the active time of the receiver and the overall power consumption. Therefore, the effective configuration of the placement of the LP-WUS may be required to reduce the operational time of the WUR without affecting the performance.

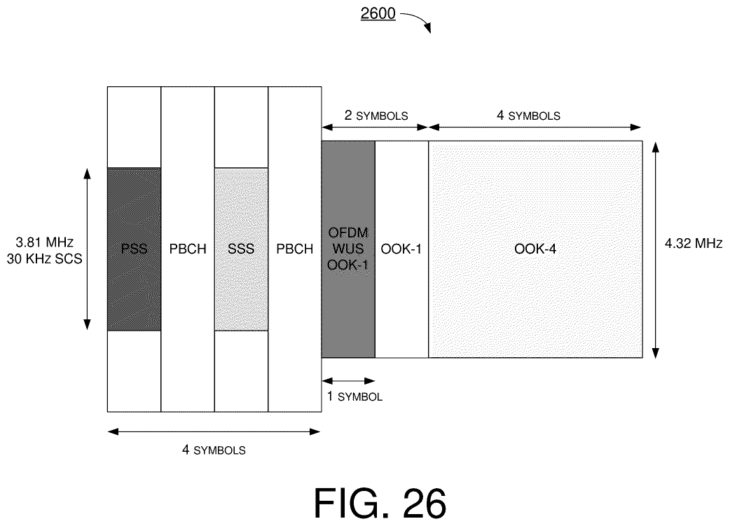

FIG. 26 illustrates an example scenario 2600 for an LP-WUS placement in accordance with implementations of the present disclosure. Referring to FIG. 26, the UE may use an OFDM WUR which uses the PSS for synchronization. The WUR may only need to monitor the PSS to achieve the synchronization without monitoring the complete SSB to reduce the monitoring duration. The PSS is a component of SSB and is a shorter and distinct part of the SSB. The SSB may also comprise the SSS and the physical broadcast channel (PBCH). Therefore, the monitoring duration can be reduced.

However, refereeing to FIG. 26, the UE may not have the option to ignore the monitoring of the SSS and additional PBCH OFDM symbols when looking for the OFDM WUS. The monitoring of the SSS and additional PBCH OFDM symbols may be tied to the processing time of deactivating the power consumption components within the UE. The deactivation process may take a period of time which may be longer than the time duration of one or a few OFDM symbols. That is, even if the WUR only use the PSS to complete the synchronization, the UE may still need to monitor the subsequent symbols to ensure that the power consumption components may not prematurely turned off. As a result, it may negate any potential power savings from the reduced monitoring duration.

The balance between the desire for a shorter monitoring duration through the use of PSS for synchronization and the practical limitations (i.e., the UE may still need to monitor the SSS and PBCH to maintain) may be required to maintain the efficient power consumption.

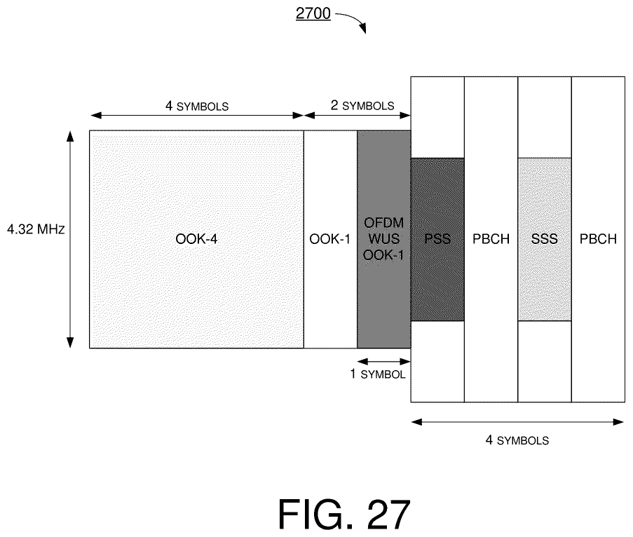

FIG. 27 illustrates another example scenario 2700 for an LP-WUS placement in accordance with implementations of the present disclosure. Referring to FIG. 27, an innovative LP-WUS placement may be provided for enhancing the power efficiency of the UE. As shown in FIG. 27, the network node may transmit the harmonized LP-WUS to the UE prior to broadcasting the SSB. The configuration for sequence where the network node dispatches the LP-WUS in advance of the SSB may make the OFDM WUR within the UE can capture and store the LP-WUS at the appropriate time. The early reception for the LP-WUS may enable the OFDM WUR to subsequently deactivate the RF components to reduce the power consumption. The UE may use the pre-stored LP-WUS and PSS to perform the synchronization and LP-WUS demodulation exclusively via the digital baseband processor without powering on the RF components. Therefore, the LP-WUS placement may particularly reduce the power consumption to perform the energy-intensive RF processing. Therefore, the battery life may be conserved.

By eliminating the requirement to monitor the additional PBCH, the UE may achieve further energy savings. The process illustrated in FIG. 27 may be designed to minimize the active monitoring duration of the WUR. Therefore, the overall power usage may be reduced. This strategic placement and processing of the LP-WUS and synchronization signals may ensure that the UE can maintain optimal performance while operating in a more energy-efficient manner.

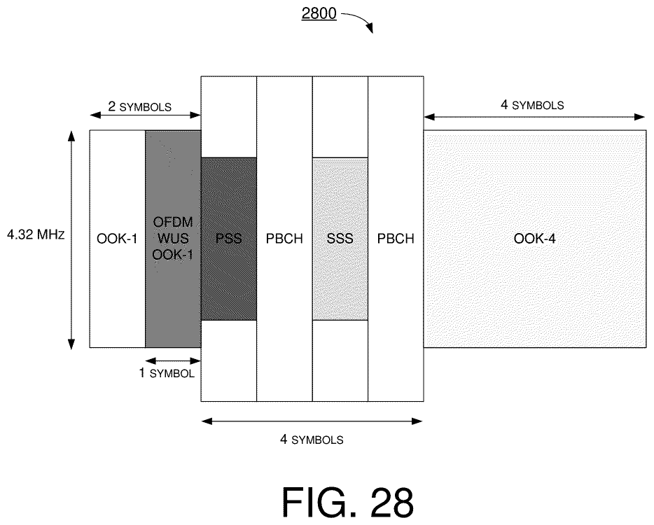

FIG. 28 illustrates another example scenario 2800 for an LP-WUS placement in accordance with implementations of the present disclosure. Referring to FIG. 28, a two-stage wake-up signaling process is provided for the UE using an OOK-based LP-WUR.

The illustrations for the LP-WUS placement illustrated in FIG. 28 may discuss how the LP-WUR uses a combination of the OOK-1 and the OFDM WUS to efficiently manage the wake-up procedure. In an initial (or first) stage of the two-stage process, the network node may transmit the OOK-based LP-WUS which may comprise both the OOK-1 WUS and OFDM WUS to the UE before the second stage associated with the LP-WUS which is modulated with OOK-4. The first stage may be positioned ahead of the SSB, and the second stage may follow the SSB. The LP-WUR may perform the operations for the OOK-1 and OFDM-WUS in the first stage, and then determine whether to proceed with the decoding of the following OOK-4 in the second stage based on the result of the first stage. If in the first stage, the LP-WUR determines that there is no LP-WUS after the SSB, the LP-WUR may terminate the monitoring for the LP-WUS which is modulated with OOK-4. Therefore, the power is conserved to avoid unnecessary signal processing.

The configuration of OOK-1 within the two-stage process may be a subset of the OOK-4 configuration. The OOK-1 may be represented by using the same amplitude or chip within a single OFDM symbol. For example, the first stage may be interpreted as “01111” from the perspective of OOK-1, rather than simply ‘01’, which may disregard the SSB. The interpretation may be feasible if the first OFDM symbol is consistently transmitted with a “0” to represent a valid OOK-4 as the second stage LP-WUS. The rationale behind this is that OOK-1 detection may be based on the energy present within an OFDM symbol. If the LP-WUS is consistently paired with the SSB, the OOK-1 detector may leverage the SSB as a reference signal. In the context, the SSB portion may be regarded as “111” from the OOK-1 perspective, allowing the LP-WUR to use the SSB to enhance the detection reliability of the LP-WUS. The innovative approach to signal detection and interpretation may increase the energy efficiency and improve the performance in the wake-up process of the UE.

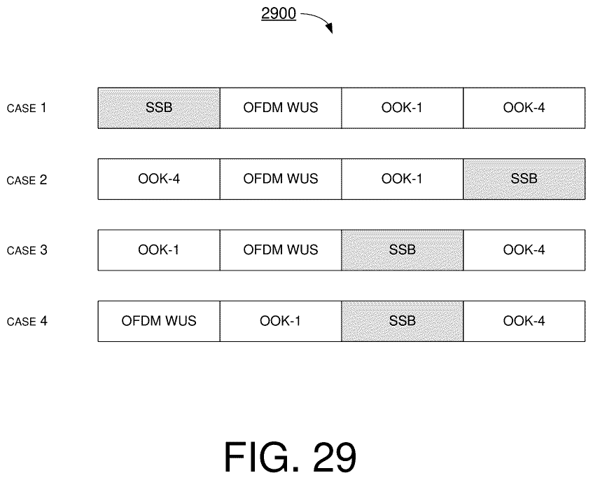

FIG. 29 illustrates an example scenario 2900 for different scheduling configurations in accordance with implementations of the present disclosure. Referring to FIG. 29, various scheduling configurations may be provided for the transmission of SSB, OFDM WUS, and OOK (e.g., OOK-1 and OOK-4) signals by a network node. Referring to FIG. 29, multiple cases may be represented different sequences in which the signals can be scheduled and transmitted to a UE.

In the first case, the sequence may begin with the SSB, followed by the OFDM WUS, then OOK-1, and end with OOK-4. The second case may present a different order, the sequence may start with OOK-4, followed by OFDM WUS, OOK-1, and end with the SSB. The third case may also present a different order, the sequence may start with OOK-1, followed by OFDM WUS, then SSB, and end with OOK-4. The fourth case may also present a different order, the sequence may start with the OFDM WUS, followed by OOK-1, then SSB, and end with OOK-4.

Referring to FIG. 29, it may be further explained that if the OFDM WUS and OOK-1 are scheduled before the SSB, the OFDM WUR within the UE may be required to monitor a total of five OFDM symbols which includes the SSB and the PBCH. The monitoring duration for the configuration may be equivalent to the scenario where the OFDM WUS is positioned after the SSB. However, placing the OFDM WUS and OOK-1 before the SSB may offer the enhanced flexibility for the network in terms of scheduling.

In addition, a scheduling offset may exist between the SSB and LP-WUS. For example, the SSB and OFDM WUS may be separated by an offset of two OFDM symbols. The configuration may be established by the network node through the SI message or the RRC message. The configurations which determine the relative timing between the OFDM WUS, OOK-1, OOK-4, and low power-secondary synchronization signal (LP-SS) may optimize the network scheduling strategy. The configurations may also be adapted to meet various operational requirements. The flexibility in scheduling may ensure that the UE can efficiently manage its power consumption while maintaining synchronization with the network node and preparing to receive wake-up signals.

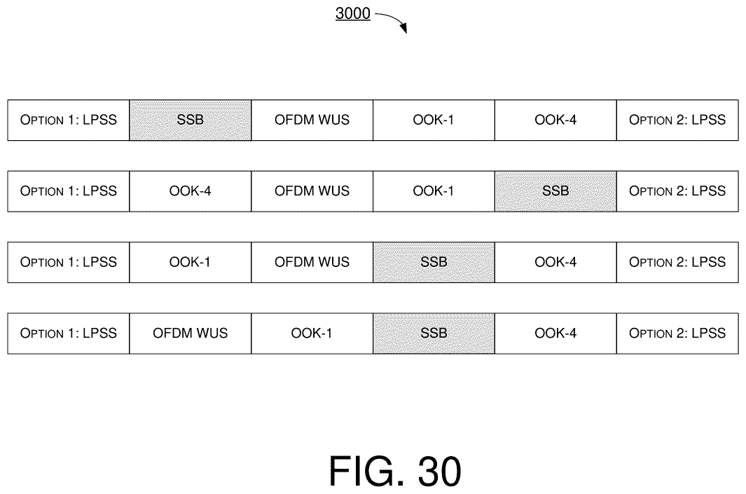

FIG. 30 illustrates an example scenario 3000 for different scheduling configurations in accordance with implementations of the present disclosure. Referring to FIG. 30, the LPSS may be incorporated into the scheduling configurations of a wireless communication network. The LPSS may be modulated based on the OOK modulation (e.g., based on the OOK-1 format or OOK-4 format). The LPSS may comprise the characteristics of lower spectral efficiency, using a larger number of OFDM symbols, and a range from 4 to 10 to convey the necessary synchronization information. The LPSS may be used for the synchronization of the UE operating in a low-power state. In addition, the LPSS may be scheduled either before or after the LP-WUS within the transmission timeline of the network node.

The network node may provide various configurations for the LPSS, e.g., the scheduling offset relative to the SSB, OFDM WUS, OOK-1, or OOK-4. In addition, the network node may determine the periodicity of the LPSS. The network node may set an interval, e.g., 160 milliseconds or 320 milliseconds, as the duration of the LPSS. The duration may be spanned 4 OFDM symbols or extended to 10 OFDM symbols at an SCS of 30 KHz. The configurations provided by the network node may also indicate the allocation of frequency resources for the LPSS. The allocation may be defined according to the resource elements or bandwidth parts (BWP).

The configurations may be transmitted to the UE via RRC messages or SI messages. The main radio of the UE may receive the RRC messages or SI messages before the initiation of the LP-WUR to ensure that the LP-WUR can be accurately informed of the timing, periodicity, and frequency resources of the LPSS before the LP-WUR begins the low-power synchronization process.

Furthermore, the configuration units for the LPSS may be represented through an absolute time, e.g., milliseconds, or through an absolute frequency, e.g., KHz. The configuration units may be designed to minimize additional signaling overhead, particularly when there are changes in the SCS. By using the absolute units, the network can efficiently transmit the LPSS configurations without large signaling to simplify the synchronization process for the UE and reduce the power consumption and signaling complexity in low-power scenarios.

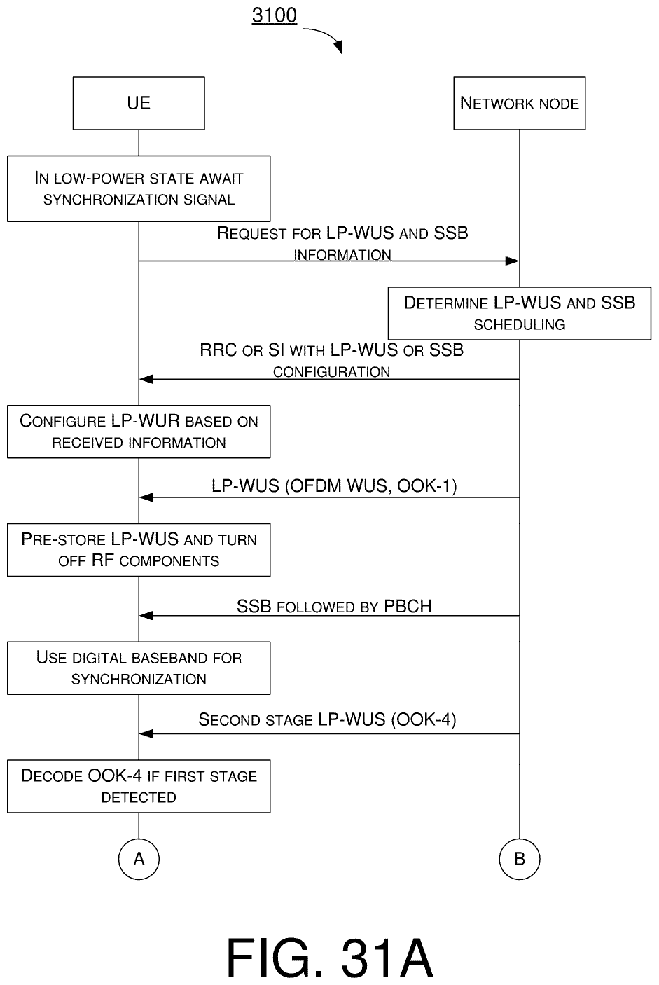

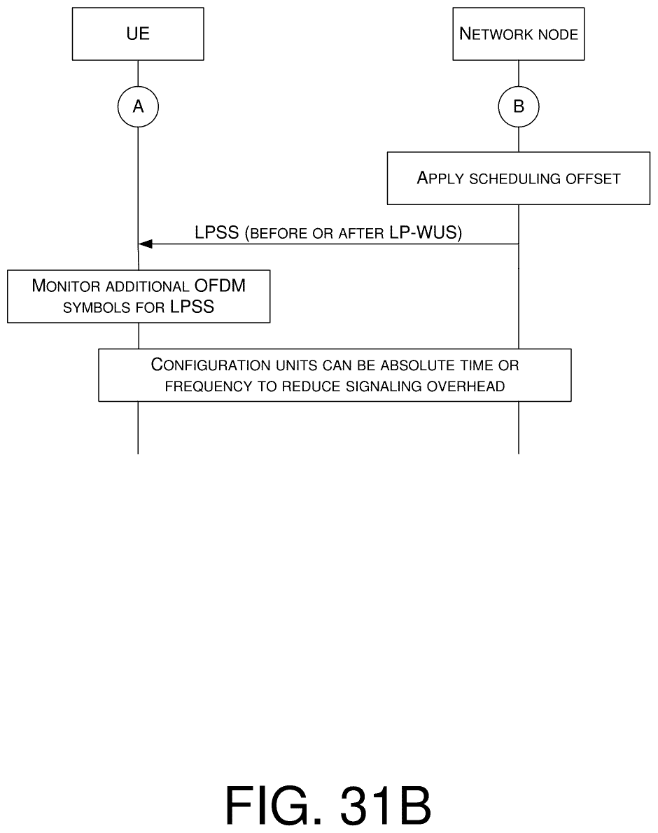

FIGS. 31A-31B illustrate an example scenario 3100 for an LP-WUS transmission process in accordance with implementations of the present disclosure. Scenario 3100 involves a UE and a network node (e.g., a (macro/micro) base station) which may be a part of a wireless network (e.g., an LTE network, a 5G/NR network, an IoT network or a 6G network). Referring to FIG. 31A-31B, the interaction between the UE and network node in the low-power state operation and synchronization may be provided. FIG. 31A-31B may provide the signaling and behavior that enable the UE to efficiently manage power consumption while maintaining synchronization with the network node. The interaction shown in FIG. 31A-31B may reflect the flexibility in scheduling, the potential for the reduced monitoring time, and the considerations for signaling overhead when configuring the SCS.

### Illustrative Implementations

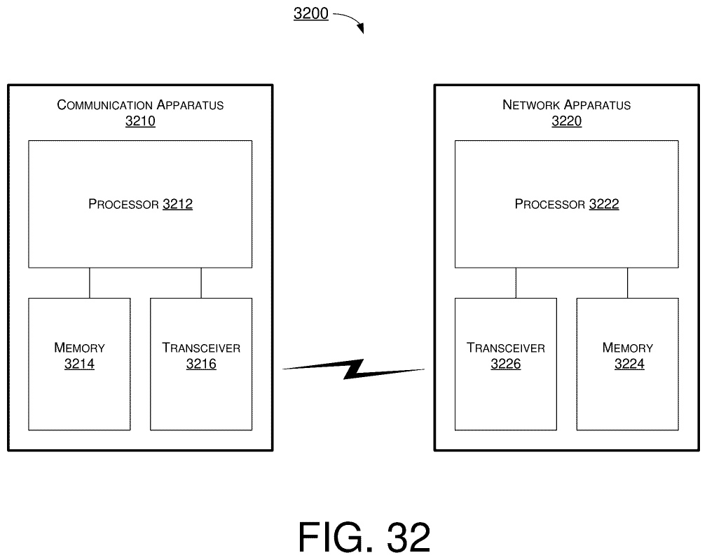

FIG. 32 illustrates an example communication system 3200 having at least an example communication apparatus 3210 and an example network apparatus 3220 in accordance with an implementation of the present disclosure. Each of communication apparatus 3210 and network apparatus 3220 may perform various functions to implement schemes, techniques, processes and methods described herein pertaining to OOK signal generation, including the various schemes described above with respect to various proposed designs, concepts, schemes and methods described above and with respect to user equipment and network apparatus in mobile communications, including scenarios/schemes described above as well as process 3300 and process 3400 described below.

Communication apparatus 3210 may be a part of an electronic apparatus, which may be a UE such as a portable or mobile apparatus, a wearable apparatus, a wireless communication apparatus or a computing apparatus. For instance, communication apparatus 3210 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 3210 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 3210 may be implemented in a smart thermostat, a smart fridge, a smart door lock, a wireless speaker or a home control center. Alternatively, communication apparatus 3210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 3210 may include at least some of those components shown in FIG. 32 such as a processor 3212, for example. Communication apparatus 3210 may further include one or more other components not pertinent to the proposed schemes of the present disclosure (e.g., internal power supply, display device and/or user interface device), and, thus, such component(s) of communication apparatus 3210 are neither shown in FIG. 32 nor described below in the interest of simplicity and brevity.

Network apparatus 3220 may be a part of an electronic apparatus, which may be a network node such as a satellite, a BS, a small cell, a router or a gateway of an IoT network. For instance, network apparatus 3220 may be implemented in a satellite or an eNB/gNB/TRP in a 4G/5G/B5G/6G, NR, IoT, NB-IoT or IIoT network. Alternatively, network apparatus 3220 may be implemented in the form of one or more IC chips such as, for example and without limitation, one or more single-core processors, one or more multi-core processors, or one or more RISC or CISC processors. Network apparatus 3220 may include at least some of those components shown in FIG. 32 such as a processor 3222, for example. Network apparatus 3220 may further include one or more other components not pertinent to the proposed scheme of the present disclosure (e.g., internal power supply, display device and/or user interface device), and, thus, such component(s) of network apparatus 3220 are neither shown in FIG. 32 nor described below in the interest of simplicity and brevity.

In one aspect, each of processor 3212 and processor 3222 may be implemented in the form of one or more single-core processors, one or more multi-core processors, or one or more CISC processors. That is, even though a singular term “a processor” is used herein to refer to processor 3212 and processor 3222, each of processor 3212 and processor 3222 may include multiple processors in some implementations and a single processor in other implementations in accordance with the present disclosure. In another aspect, each of processor 3212 and processor 3222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 3212 and processor 3222 is a special-purpose machine specifically designed, arranged and configured to perform specific tasks, including OOK signal generation, in a device (e.g., as represented by communication apparatus 3210) and a network node (e.g., as represented by network apparatus 3220) in accordance with various implementations of the present disclosure.

In some implementations, communication apparatus 3210 may also include a transceiver 3216 coupled to processor 3212 and capable of wirelessly transmitting and receiving data. In some implementations, transceiver 3216 may be capable of wirelessly communicating with different types of UEs and/or wireless networks of different radio access technologies (RATs). In some implementations, transceiver 3216 may be equipped with a plurality of antenna ports (not shown) such as, for example, four antenna ports. That is, transceiver 3216 may be equipped with multiple transmit antennas and multiple receive antennas for multiple-input multiple-output (MIMO) wireless communications. In some implementations, network apparatus 3220 may also include a transceiver 3226 coupled to processor 3222. Transceiver 3226 may include a transceiver capable of wirelessly transmitting and receiving data. In some implementations, transceiver 3226 may be capable of wirelessly communicating with different types of UEs of different RATs. In some implementations, transceiver 3226 may be equipped with a plurality of antenna ports (not shown) such as, for example, four antenna ports. That is, transceiver 3226 may be equipped with multiple transmit antennas and multiple receive antennas for MIMO wireless communications.

In some implementations, communication apparatus 3210 may further include a memory 3214 coupled to processor 3212 and capable of being accessed by processor 3212 and storing data therein. In some implementations, network apparatus 3220 may further include a memory 3224 coupled to processor 3222 and capable of being accessed by processor 3222 and storing data therein. Each of memory 3214 and memory 3224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 3214 and memory 3224 may include a type of read-only memory (ROM) such as mask ROM, programmable ROM (PROM), erasable programmable ROM (EPROM) and/or electrically erasable programmable ROM (EEPROM). Alternatively, or additionally, each of memory 3214 and memory 3224 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 3210 and network apparatus 3220 may be a communication entity capable of communicating with each other using various proposed schemes in accordance with the present disclosure. For illustrative purposes and without limitation, descriptions of capabilities of communication apparatus 3210, as a UE, and network apparatus 3220, as a network node (e.g., TRP), are provided below with process 3300 and process 3400.

### Illustrative Processes

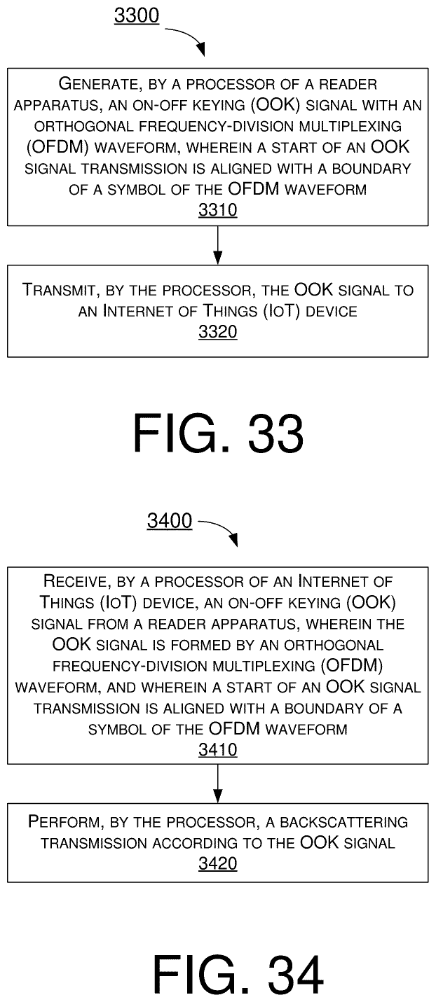

FIG. 33 illustrates an example process 3300 in accordance with an implementation of the present disclosure. Process 3300 may be an example implementation of above scenarios/schemes, whether partially or completely, with respect to OOK signal generation with the present disclosure. Process 3300 may represent an aspect of implementation of features of communication apparatus 3210. Process 3300 may include one or more operations, actions, or functions as illustrated by one or more of blocks 3310, and 3320. Although illustrated as discrete blocks, various blocks of process 3300 may be divided into additional blocks, combined into fewer blocks, or eliminated, depending on the desired implementation. Moreover, the blocks of process 3300 may be executed in the order shown in FIG. 33 or, alternatively, in a different order. Process 3300 may be implemented by communication apparatus 3210 or any suitable reader apparatus. Solely for illustrative purposes and without limitation, process 3300 is described below in the context of communication apparatus 3210. Process 3300 may begin at block 3310.

At 3310, process 3300 may involve processor 3212 of communication apparatus 3210 generating an OOK signal with an OFDM waveform, wherein a start of an OOK signal transmission is aligned with a boundary of a symbol of the OFDM waveform. Process 3300 may proceed from 3310 to 3320.

At 3320, process 3300 may involve processor 3212 transmitting, via transceiver 3216, the OOK signal to an IoT device.

In some implementations, the OOK signal may comprise at least one of a preamble, a payload and CRC bits.

In some implementations, the OFDM waveform may comprise a PSS or an SSS.

In some implementations, the OOK signal may comprise at least one of an OOK-1 modulation and an OOK-4 modulation.

In some implementations, process 3300 may involve processor 3212 transmitting, via transceiver 3216, a configuration associated with the OOK signal to the IoT device, wherein the configuration comprises at least one of a signal format and a bandwidth allocation of the OOK signal.

In some implementations, process 3300 may involve processor 3212 transmitting, via transceiver 3216, a guard band configuration between the OOK signal and another OFDM signal to the IoT device.

In some implementations, the OOK signal may comprise a wake-up signal to wake up the IoT device.

FIG. 34 illustrates an example process 3400 in accordance with another implementation of the present disclosure. Process 3400 may be an example implementation of above scenarios/schemes, whether partially or completely, with respect to OOK signal generation with the present disclosure. Process 3400 may represent an aspect of implementation of features of network apparatus 3220. Process 3400 may include one or more operations, actions, or functions as illustrated by one or more of blocks 3410 and 3420. Although illustrated as discrete blocks, various blocks of process 3400 may be divided into additional blocks, combined into fewer blocks, or eliminated, depending on the desired implementation. Moreover, the blocks of process 3400 may be executed in the order shown in FIG. 34 or, alternatively, in a different order. Process 3400 may be implemented by communication apparatus 3210 or any suitable IoT device. Solely for illustrative purposes and without limitation, process 3400 is described below in the context of communication apparatus 3210. Process 3400 may begin at block 3410.

At 3410, process 3400 may involve processor 3212 of communication apparatus 3210 receiving, via transceiver 3216, an OOK signal from a reader apparatus, wherein the OOK signal is formed by an OFDM waveform, and wherein a start of an OOK signal transmission is aligned with a boundary of a symbol of the OFDM waveform. Process 3400 may proceed from 3410 to 3420.

At 3420, process 3400 may involve processor 3212 performing a backscattering transmission according to the OOK signal.

In some implementations, process 3400 may involve processor 3212 receiving, via transceiver 3216, a configuration associated with the OOK signal from the reader apparatus, wherein the configuration comprises at least one of a signal format and a bandwidth allocation of the OOK signal.

In some implementations, process 3400 may involve processor 3212 receiving, via transceiver 3216, a guard band configuration between the OOK signal and another OFDM signal from the reader apparatus.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of a reader apparatus, an on-off keying (OOK) signal with an orthogonal frequency-division multiplexing (OFDM) waveform, wherein a start of an OOK signal transmission is aligned with a boundary of a symbol of the OFDM waveform; and
transmitting, by the processor, the OOK signal to an Internet of Things (IoT) device.

2. The method of claim 1, wherein the OOK signal comprises at least one of a preamble, a payload and cyclic redundancy check (CRC) bits.

3. The method of claim 1, wherein the OFDM waveform comprises a primary synchronization signal (PSS) or a secondary synchronization signal (SSS).

4. The method of claim 1, wherein the OOK signal comprises at least one of an OOK-1 modulation and an OOK-4 modulation.

5. The method of claim 1, further comprising:
transmitting, by the processor, a configuration associated with the OOK signal to the IoT device, wherein the configuration comprises at least one of a signal format and a bandwidth allocation of the OOK signal.

6. The method of claim 1, further comprising:
transmitting, by the processor, a guard band configuration between the OOK signal and another OFDM signal to the IoT device.

7. The method of claim 1, wherein the OOK signal comprises a wake-up signal to wake up the IoT device.

8. A method, comprising:
receiving, by a processor of an Internet of Things (IoT) device, an on-off keying (OOK) signal from a reader apparatus, wherein the OOK signal is formed by an orthogonal frequency-division multiplexing (OFDM) waveform, and wherein a start of an OOK signal transmission is aligned with a boundary of a symbol of the OFDM waveform; and
performing, by the processor, a backscattering transmission according to the OOK signal.

9. The method of claim 8, wherein the OOK signal comprises at least one of a preamble, a payload and cyclic redundancy check (CRC) bits.

10. The method of claim 8, wherein the OFDM waveform comprises a primary synchronization signal (PSS) or a secondary synchronization signal (SSS).

11. The method of claim 8, wherein the OOK signal comprises at least one of an OOK-1 modulation and an OOK-4 modulation.

12. The method of claim 8, further comprising:
receiving, by the processor, a configuration associated with the OOK signal from the reader apparatus, wherein the configuration comprises at least one of a signal format and a bandwidth allocation of the OOK signal.

13. The method of claim 8, further comprising:
receiving, by the processor, a guard band configuration between the OOK signal and another OFDM signal from the reader apparatus.

14. The method of claim 8, wherein the OOK signal comprises a wake-up signal to wake up the IoT device.

15. An apparatus, comprising:
a transceiver which, during operation, wirelessly communicates with at least one network node of a wireless network; and
a processor communicatively coupled to the transceiver such that, during operation, the processor performs operations comprising:
generating an on-off keying (OOK) signal with an orthogonal frequency-division multiplexing (OFDM) waveform, wherein a start of an OOK signal transmission is aligned with a boundary of a symbol of the OFDM waveform; and
transmitting, via the transceiver, the OOK signal to an Internet of Things (IoT) device.

16. The apparatus of claim 15, wherein the OOK signal comprises at least one of a preamble, a payload and cyclic redundancy check (CRC) bits.

17. The apparatus of claim 15, wherein the OFDM waveform comprises a primary synchronization signal (PSS) or a secondary synchronization signal (SSS).

18. The apparatus of claim 15, wherein the OOK signal comprises at least one of an OOK-1 modulation and an OOK-4 modulation.

19. The apparatus of claim 15, wherein the processor is further configured to perform operations comprising:
transmitting, via the transceiver, a configuration associated with the OOK signal to the IoT device, wherein the configuration comprises at least one of a signal format and a bandwidth allocation of the OOK signal.

20. The apparatus of claim 15, wherein the processor is further configured to perform operations comprising:
transmitting, via the transceiver, a guard band configuration between the OOK signal and another OFDM signal to the IoT device.
